(19) United States
(12) Patent Application Publication
(10) Pub. No.: US 2009/0174173 A1
(43) Pub. Date: Jul. 9, 2009

(54) Knee protection airbag system

(75) Inventors: Yuichi Adachi, Aichi-ken (JP); Kazuaki Bito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Nishikasugai-gun (JP)

(21) Appl. No.: 12/318,147

(22) Filed: Dec. 22, 2008

(30) Foreign Application Priority Data
Dec. 25, 2007 (JP) 2007-332693

(51) Int. Cl. B60R 21/16

(52) U.S. Cl. 280/730.1

(57) ABSTRACT

In a knee protection airbag system of the invention, an airbag includes an inlet port portion which is connected to an inflator in the vicinity of a longitudinal and transverse center of the airbag when it is inflated completely. A front tether and a rear tether which connect a driver-side wall portion with a column-side wall portion provided forwards and rearwards of the inlet port portion, respectively. The front tether and the rear tether are made to rectify an inflation gas which has flowed from the inlet port portion so that the inflation gas flows towards left and right or transverse ends of a central portion and thereafter to cause the inflation gas to flow out into a front portion and a rear portion by way of outlet path portions. The outlet path portions are made larger in a total sum of open areas than the outlet path portions.

### BACKGROUND OF THE INVENTION

1. Field of the Invention

The present invention relates to a knee protection airbag system in which the knees of the driver are protected by an inflated airbag and more particularly to a steering column attached knee protection airbag system in which a folded airbag is accommodated at a lower portion in a column cover which is provided so as to cover a steering column.

2. Related Art

Conventionally, in a steering column attached knee protection airbag system, a configuration is adopted in which when activated, an inflation gas is supplied into an interior of an airbag which is folded to be accommodated at a lower portion within a column cover, and the airbag is then caused to project from the column cover to thereby be disposed at a front side of the knees of the driver in a longitudinal direction of a vehicle while being deployed and inflated (for example, refer to JP-A-2002-37003).

Specifically, in the conventional knee protection airbag system, when activated, an inflator disposed within the airbag discharged the inflation gas in an obliquely downward direction on both left- and right-hand sides thereof, and the airbag was then deployed and inflated radially from substantially a center of the column cover, so that the knees of the driver could be protected from the column cover so as to expand widely both the knees of the driver by the airbag which is being so inflated.

However, there occurs a situation in which both the knees cannot be expanded widely due to the cloths worn by or seated posture of the driver when the airbag is inflated, and in such a case, the knees are not protected sufficiently by the conventional knee protection airbag system.

In addition, in consideration of the point described above, the airbag is desirably made to be deployed widely in a transverse direction so as to protect both the knees of the driver from the column cover and portions of an instrument panel which lie on the periphery of the column cover by being deployed widely in the transverse direction in front of the knees of the driver.

However, since the column cover itself which accommodates therein the airbag lies close to the knees of the driver who is seated in the driver's seat, the airbag which projects from the column cover becomes easy to be brought into contact with the knees of the driver, and with the conventional knee protection airbag system, there has been a problem in deploying the airbag widely in a transverse direction at the front side of the knees of the driver.

### SUMMARY OF THE INVENTION

The invention has been made with a view to solving the problem, and an object thereof is to provide a knee protection airbag system in which an airbag projecting from a column cover is deployed and inflated widely in a transverse direction in an initial stage of inflation and can be inflated further in a smooth fashion so as to increase its thickness.

With a view to achieving the object, according to an aspect of the invention, there is provided a knee protection airbag system installed in a lower portion in a column cover which covers a steering column, including a folded airbag and an inflator for supplying an inflation gas into the airbag which are accommodated in the lower portion in the column cover, whereby when activated, the inflation gas is supplied into the airbag from the inflator, and the airbag is caused to project from the column cover while being deployed and inflated so as to complete its inflation to be disposed at a front side of knees of the driver in a longitudinal direction of a vehicle, while covering a lower surface side of the column cover and a rear surface side of an instrument panel on both left-hand and right-hand sides of the column cover, wherein the airbag includes a driver-side wall portion which is disposed on a side facing the driver and a column-side wall portion which is disposed on a side facing the column cover when the airbag is completely inflated and has an inlet port portion which is made to be disposed in the vicinity of a longitudinally and transversely center thereof when the airbag is completely inflated so as to be connected to the inflator so as to allow the inflation gas from the inflator to flow into an interior of the airbag, wherein a front tether and a rear tether which connect the driver-side wall portion and the column-side wall portion so as to restrict a thickness of the airbag when the airbag is completely inflated are provided so as to extend along substantially a transverse direction on a front side and a rear side of the inlet port portion inside the airbag, wherein the front tether and the rear tether are made to rectify the inflation gas which has flowed into the interior of the airbag from the inlet port portion so as to cause the inflation gas to flow towards both left and right ends of a central portion in the airbag which is made up of an area surrounded by the front tether and the rear tether and thereafter to cause the inflation gas to flow out into a front portion in the air bag which is made up of an area lying forwards of the front tether and a rear portion in the airbag which is made up of an area lying rearwards of the rear tether by way of outlet path portions provided at transverse end portions of the airbag when the airbag is completely inflated, and wherein the outlet paths portions for causing the inflation gas to flow out into the front portion are made larger in a total sum of open areas than the outlet path portions for causing the inflation gas to flow out into the rear portion.

In the knee protection airbag system according to the aspect of the invention, when the inflation gas is discharged from the inflator as a result of activation of the system, the inflation gas flows into the airbag by way of the inlet port portion. Then, the inflation gas which has flowed into the airbag from the inlet port portion is guided by the front tether and the rear tether to be caused to flow through the central portion towards the left and right ends. Because of this, when having projected from the column cover, the airbag folded and accommodated is firstly deployed and inflated so as to expand the central portion widely in the transverse direction. As this occurs, the front portion and the rear portion are deployed in the transverse direction in association with the deployment of the central portion towards the left and right ends in such a state that the front portion and the rear portion are not inflated thick. In addition, thereafter, with the inflation gas caused to flow into the front portion and the rear portion by way of the outlet path portions which are provided at the transverse end portions of the front tether and the rear tether from the transverse end portions towards the center, the airbag is inflated thick at the front portion and the rear portion while being deployed widely in the longitudinal direction, whereby the inflation of the airbag is completed.

Consequently, in the knee protection airbag of the invention, in the knee protection airbag system of the aspect of the invention, since the airbag which projects from the column cover is deployed and inflated widely in the transverse direction in the initial inflation process, and is then inflated further in a smooth fashion so as to increase the thickness thereof, even in the event that the column cover lies close to the knees of the driver seated in the driver's seat, the airbag is inflated smoothly so as to be disposed at the front side of the knees of the driver.

In addition, in the knee protection airbag system of the invention, since the outlet path portions which cause the inflation gas into the front portion are made larger in a total sum of open areas than the outlet path portions, the front portion can be made to be inflated more quickly than the rear portion. Namely, in the knee protection airbag system according to the aspect of the invention, since the front portion of the airbag which lies on the side of the knees of the driver which lies on the side facing the traveling direction of the vehicle can be made to be inflated more quickly than the rear portion by causing the inflation gas to flow more quickly into the front portion than into the rear portion, the front portion of the airbag can be inflated before the driver is moved forwards, and even when the driver who is seated in the driver's seat with the knees left lying close to the column cover, the knees of the driver can be received by the front portion itself of the airbag which has completed its inflation quickly or the central portion which is inflated so as to be supported by the front portion so inflated.

Further, in the knee protection airbag system according to the aspect of the invention, in the event that the airbag is formed into a substantially trapezoidal configuration in which a transverse width dimension gets narrower towards a front edge side as an external configuration resulting when the airbag is completely inflated and that a volume of the front portion is made smaller than a volume of the rear portion when the airbag is completely inflated, the front portion can preferably be inflated more quickly than the rear portion.

Furthermore, in the knee protection airbag system according to the aspect of the invention, it is preferable that the airbag is made by joining the driver-side wall portion and the column-side wall portion which are made to have substantially the same external shapes to each other along outer circumferential edges of the driver-side wall portion and the column-side wall portion, and is accommodated by being folded from a state in which the driver-side wall portion and the column-side wall portion are deployed flat to be superposed one on the other firstly through a longitudinal contraction folding in which the driver-side wall portion and the column-side wall portion are folded so as to decrease a longitudinal width dimension and then through a transverse contraction folding in which the driver-side wall portion and the column-side wall portion are folded so as to decrease the transverse width dimension, the transverse contraction folding being made up of a roll folding in which transverse edge portions of the airbag are folded into a roll towards the driver-side wall portion.

In the knee protection airbag system configured as described above, since the airbag which has projected from the column cover by the inflation gas being caused to flow into the interior thereof is deployed widely in the transverse direction so as to unfold the roll folding and thereafter is deployed so as to be expanded in the longitudinal direction, the airbag can be made to be deployed in the transverse direction more quickly by suppressing its longitudinal deployment in the initial stage of inflation.

Furthermore, in the knee protection airbag system configured as described above, a configuration may be adopted in which the airbag is made by joining the driver-side wall portion and the column-side wall portion which are made to have substantially the same external shapes to each other along outer circumferential edges of the driver-side wall portion and the column-side wall portion, and is accommodated by being folded from a state in which the driver-side wall portion and the column-side wall portion are deployed flat to be superposed one on the other firstly by implementing a preliminary folding in which transverse end portions of rear edges of the rear portions of the driver-side wall portion and the column-side wall portion so superposed are folded so as to intersect the rear tether but not to intersect the front tether and the transverse end portions are then folded back individually towards the column-side wall portion and folding thereafter the driver-side wall portion and the column-side wall portion so preliminarily folded firstly through a longitudinal contraction folding in which the driver-side wall portion and the column-side wall portion are folded so as to decrease a longitudinal width dimension and a transverse contraction folding in which the driver-side wall portion and the column-side wall portion are folded so as to decrease the transverse width dimension.

In the event that the knee protection airbag system is configured in the manner described above, the outlet path portions provided on the rear tether side are closed by the folds of the preliminary folding. In addition, since the airbag that has projected from the column cover is deployed so as to unfold the preliminarily folded portions after it has been expanded or deployed longitudinally and transversely, the flow of the inflation gas into the rear portion can be delayed, and on the contrary, the inflation gas can be caused to flow into the front portion quickly, whereby the front portion can be inflated more quickly.

### BRIEF DESCRIPTION OF THE DRAWINGS

FIG. 1 is a schematic side view showing surroundings of a column cover in which a knee protection airbag system of a first embodiment of the invention is installed.

FIG. 2 is a schematic enlarged vertical sectional view taken along a longitudinal direction which shows the surroundings of the column cover in which the knee protection airbag system of the first embodiment is installed.

FIG. 3 is a schematic enlarged horizontal or plan sectional view showing the surroundings of the column cover in which the knee protection airbag system of the first embodiment is installed, which corresponds to a portion taken along the line III-III in FIG. 2.

FIG. 4 is an exploded perspective view showing a case and an inflator which are used in the knee protection airbag system of the first embodiment.

FIG. 5 is a plan view of a lower portion of the column cover in which the knee protection airbag system of the first embodiment of the invention is installed.

FIG. 6 are perspective views showing a state before a door portion is opened and a state after the door portion is opened in the column cover in which the knee protection airbag system of the first embodiment of the invention is installed.

FIG. 7 is a plan view of the airbag which is used in the knee protection airbag system of the first embodiment.

FIG. 8 is a bottom view of the airbag shown in FIG. 7.

FIG. 9 is a vertical sectional view showing a state in which the inflator is assembled in the airbag shown in FIG. 7, which corresponds to a portion taken along the line IX-IX in FIG. 7.

FIG. 10 is a schematic cross-sectional view of the airbag shown in FIG. 7 which shows a state in which the airbag is inflated alone, which corresponds to a portion taken along the line X-X in FIG. 7.

FIGS. 11A to 11D are diagrams explaining steps of folding the airbag used in the knee protection airbag system of the first embodiment.

FIGS. 12A and 12B are side views showing sequentially operating states of the knee protection airbag system of the first embodiment.

FIGS. 13A and 13B are side views showing sequentially operating states of the knee protection airbag system of the first embodiment, which occur after the operations shown in FIGS. 12A and 12B.

FIGS. 14A and 14B are schematic vertical sectional views taken along the transverse direction which show sequentially operating states of the knee protection airbag system of the first embodiment, which correspond to a portion taken along the line XIV-XIV in FIG. 1.

FIGS. 15A and 15B are schematic vertical sectional views showing sequentially operating states of the knee protection airbag system of the first embodiment, which occur after the operating states shown in FIGS. 14A and 14B.

FIG. 16 is a schematic enlarged vertical sectional view taken along a longitudinal direction which shows a state in which the airbag completes its inflation in the knee protection airbag system of the first embodiment.

FIG. 17 is a schematic enlarged vertical sectional view taken along the transverse direction which shows surroundings of a column cover in which a knee protection airbag system of a second embodiment of the invention.

FIG. 18 is a schematic enlarged vertical view taken along the transverse direction which show surroundings of the column cover in which the knee protection airbag system of the second embodiment is installed.

FIG. 19 is a plan view of an airbag used in the knee protection airbag system of the second embodiment.

FIGS. 20A, 20B and 20C are diagrams explaining folding steps of the airbag used in the knee protection airbag system of the second embodiment.

FIGS. 21A, 21B and 21C are diagrams explaining folding steps of the airbag used in the knee protection airbag system of the second embodiment, which occur after the steps shown in FIGS. 20A, 20B and 20C.

FIG. 22 is a schematic enlarged vertical sectional view taken along the longitudinal direction, which shows a state in which the airbag completes its inflation.

FIG. 23 is a plan view showing a modified example of an airbag.

FIG. 24 is a schematic sectional view taken along the transverse direction showing the airbag shown in FIG. 23, which corresponds to a portion taken along the line XXIV-XXIV in FIG. 23.

### DETAILED DESCRIPTION OF THE PREFERRED EMBODIMENTS

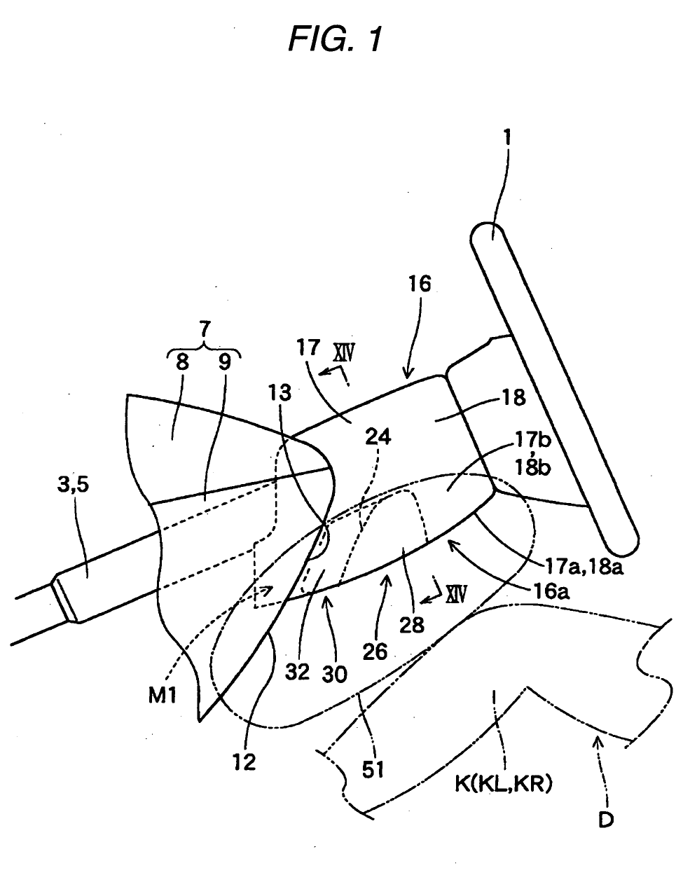

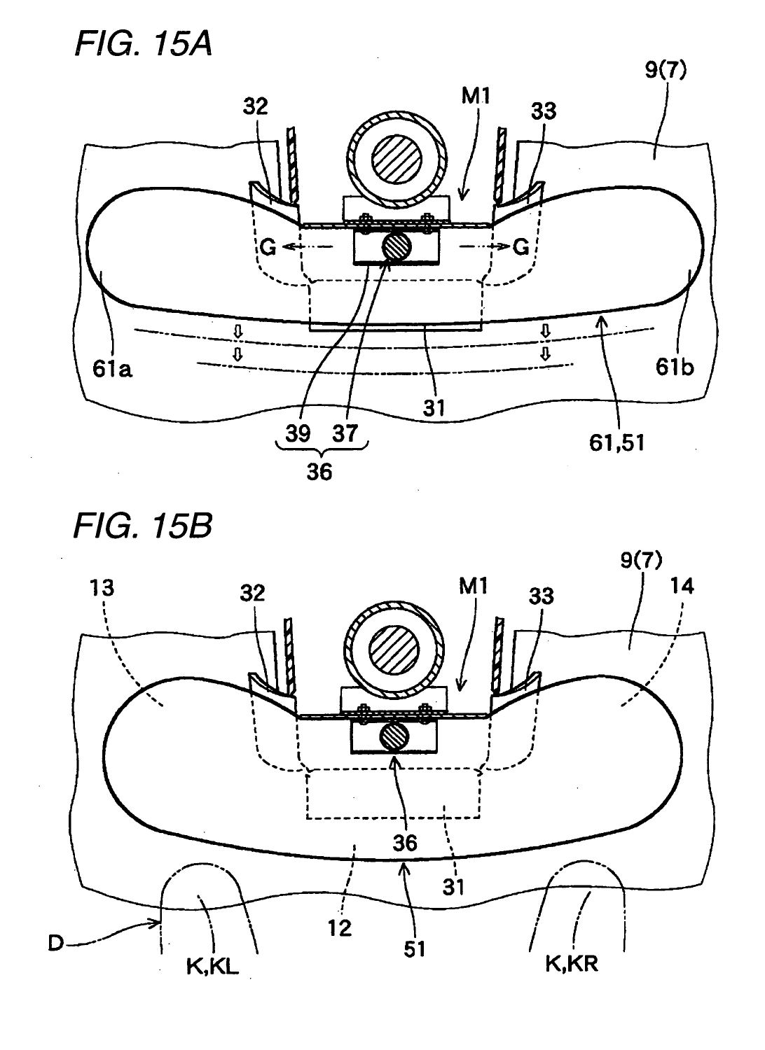

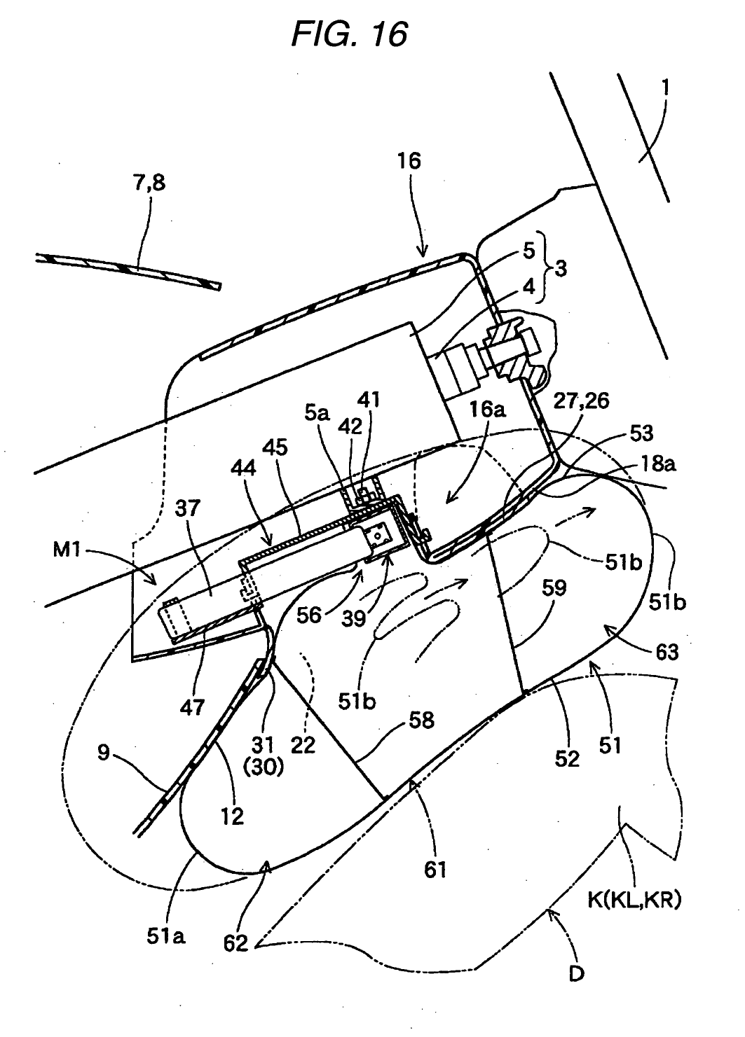

Hereinafter, an embodiment of the invention will be described based on the accompanying drawings. A knee protection airbag system M1 according to a first embodiment is, as is shown in FIGS. 1 to 3, made up of a folded airbag 51 and an inflator 36 for supplying an inflation gas G into the airbag 51 which are accommodated at a lower portion 16a in a column cover 16. More specifically, the knee protection airbag system M1 is made up of the airbag 51, the inflator 36 and an accommodation case 44 which accommodates therein the airbag 51 and the inflator 36 and is configured such that when inflated, the airbag 51 push opens a door portion 26 and an auxiliary door portion 30 which are provided in the column cover 16 to project from the column cover 16 and is disposed at a front side of both knees K (KL, KR) of the driver who is seated in a driver's seat in a longitudinal direction of a vehicle so as to cover a lower surface 18a side of the column cover 16 and rear surfaces 12, 13, 14 of an instrument panel 7 which expand from a lower side to left- and right-hand sides of the column cover 16 (refer to FIGS. 15B and 16).

Note that when used in this specification, longitudinal, vertical and transverse directions are referred as below unless described otherwise. A direction which follows a longitudinal direction of a steering column 3 is referred to as a longitudinal direction, a transverse direction which intersects an axial direction of the steering column 3 at right angles is referred to as a transverse direction, and a direction which intersects the axial direction of the steering column 3 at right angles is referred to as a vertical direction.

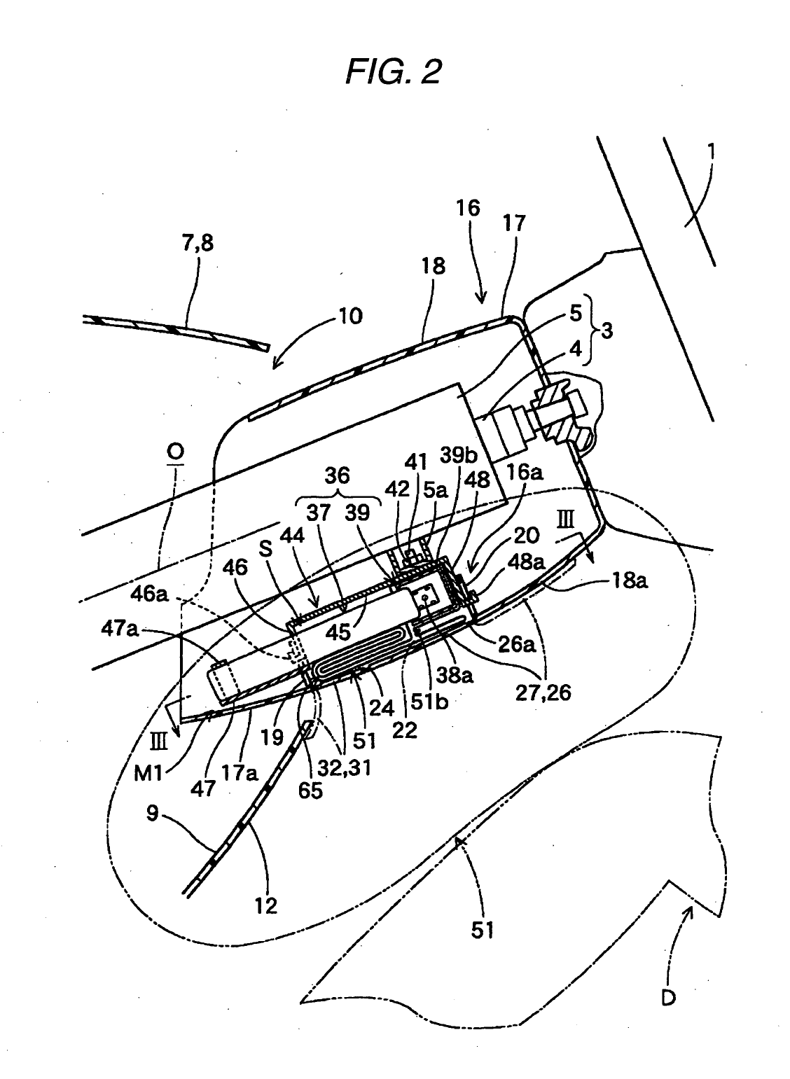

As is shown in FIGS. 1 and 2, the column cover 16 is formed from a synthetic resin into a substantially quadrangular tubular configuration so as to cover the steering column 3. The column cover 16 is attached to a column tube 5 of the steering column 3 at a portion, not shown, and projects from an accommodation opening 10 formed in the instrument panel 7 to the rear so as to be disposed in front of a driver D seated in a driver's seat with a front end positioned lower and a rear end positioned upper so as to extend along an axial direction O (refer to FIG. 2) of the steering column 3. In addition, the steering column 3 is made up of a main shaft 4 and the column tube 5 which is disposed to surround the main shaft 4, and a steering wheel 1 is connected to the main shaft 4. In addition, the instrument panel 7 is made up of an upper panel 8 provided on an upper side and a lower panel 9 provided on a lower side thereof.

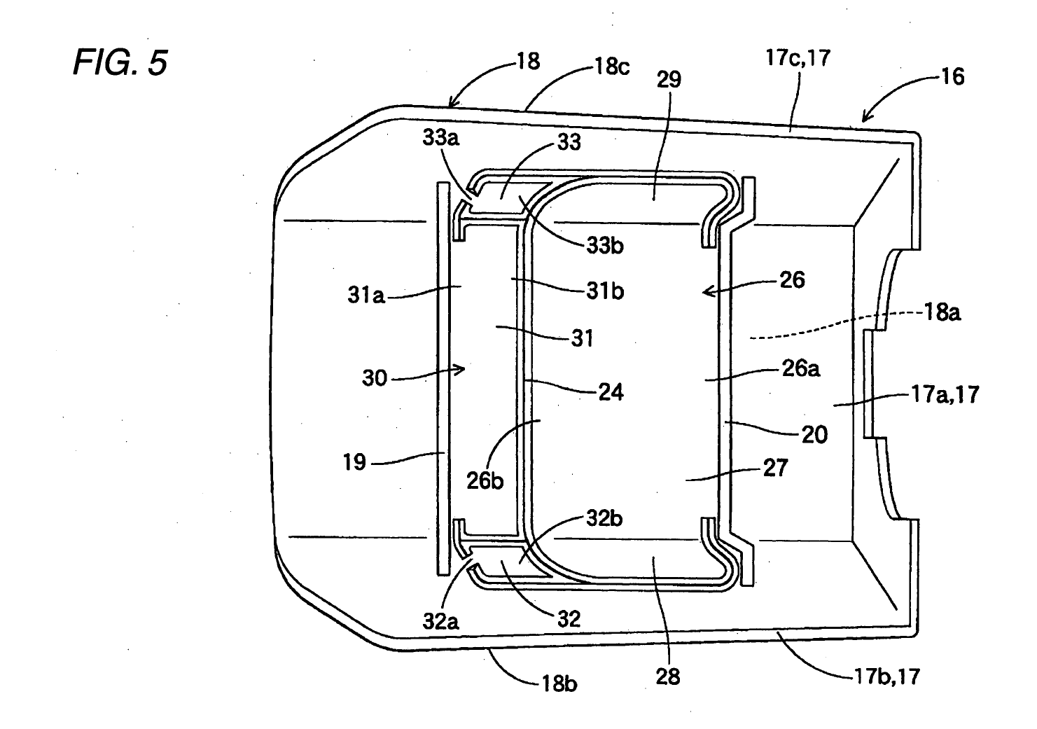

In addition, as is shown in FIGS. 1 to 3, 5 and 6, the door portion 26 is provided in an area which expands from the lower surface 18a side to a left side surface 18b and a right side surface 18c of an outer circumferential surface 18 so as to be push opened by the airbag 51 to form a projecting opening 22 when the airbag 51 is caused to project. The door portion 26 is disposed further rearwards than the rear surfaces (lower surfaces) 12, 13, 14 of the instrument panel 7 (refer to FIGS. 1, 2, 15B and 16) and is made up of a lower door portion 27 which is disposed on the lower surface 18a side of the column cover 16, a left door portion 28 which is disposed on the left side surface 18b side of the column cover 16 and a right door portion 29 which is disposed on the right side surface 18c side of the column cover 16. In addition, a breakable portion 24 which is expected to be broken by being pushed by the airbag 51 being inflated is formed on the periphery of the door portion 26. The breakable portion 24 is formed by providing a continuing linear recessed groove on an inner circumferential surface side of a circumferential wall portion 17 which makes up the column cover 16 so as to decrease the thickness of the column cover 16.

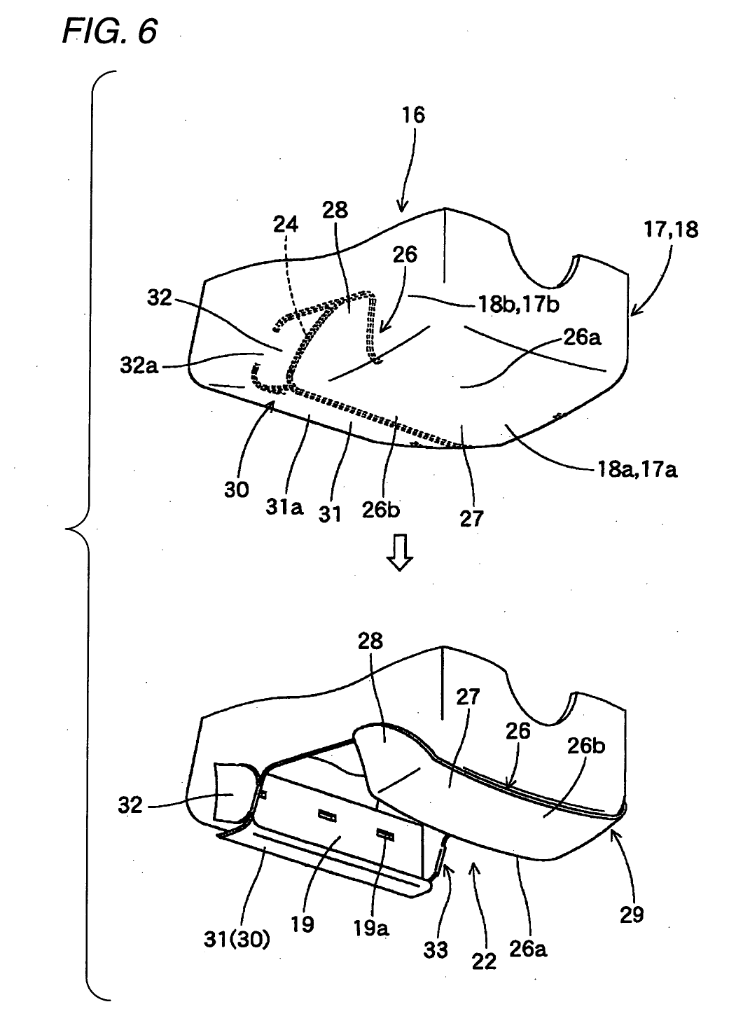

In addition, the door portion 26 rotates a front edge 26b side to the rear to open about a hinge portion 26a made up of an integral hinge portion disposed a rear edge side of the lower door portion 27 as a rotational center, and the left door portion 28 and the right door portion 29 are disposed such that as the door portion 26 so opens, the left door portion 28 and the right door portion 29 open, as is shown in FIG. 6, to the rear together with the lower door portion 27 with lower edge sides thereof which result before opening connected respectively to left and right edges of the lower door portion 27 and are then turned over to be brought into contact with the left side surface 18b and the right side surface 18c of the column cover 16.

In addition, in the case of this embodiment, as is shown in FIGS. 1 to 3, 5 and 6, the auxiliary door portion 30 is provided on a front side of the door portion 26 on the column cover 16 so as to be push opened by the airbag 51 together with the door portion 26 so as to increase the area of the projecting opening 22 of the airbag 51. The auxiliary door portion 30 is made up of an auxiliary lower door portion 31 which is disposed on the lower surface 18a side of the column cover 16, an auxiliary left door portion 32 which is disposed on the left side surface 18b side of the column cover 16 and an auxiliary right door portion 33 which is disposed on the right side surface 18c side of the column cover 16 with breakable portions 24 disposed on the peripheries of the respective auxiliary door portions so disposed. The auxiliary lower door portion 31, the auxiliary left door portion 32 and the auxiliary right door portion 33 are disposed so as to open by rotating their rear edges 31b, 32b, 33b to the front with their hinge portions 31a, 32a, 33a made up of integral hinges disposed on their front edge sides, respectively.

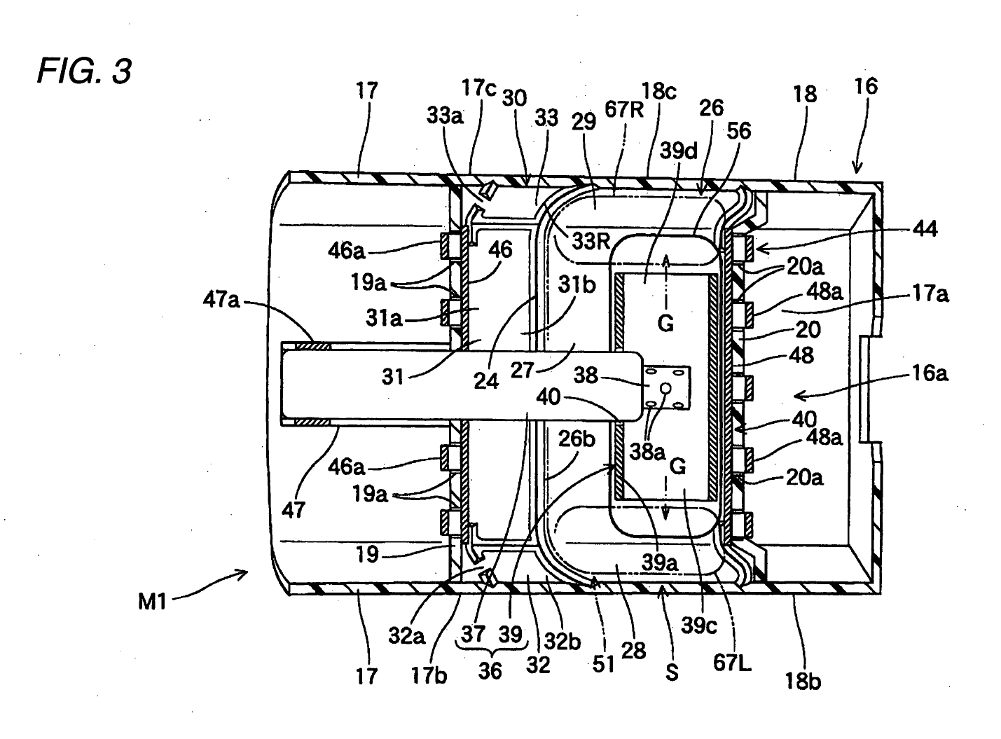

In addition, as is shown in FIGS. 2, 3 and 5, side walls 19, 20 which extend upwards from a lower wall 17a of the circumferential wall portion 17 are formed on front and rear edges of an area forming the projecting opening 22, that is, the front edge side of the auxiliary door portion 30 and the rear edge side of the door portion 26, respectively, such that both left and right edges thereof are connected to a left side wall 17b and a right side wall 17c of the circumferential wall portion 17 within the column cover 16. The side walls 19, 20 are such as to define and specify an accommodation space S of the folded airbag 51 together with the case 44 within the column cover 16. Further, these side walls 19, 20 also function as attaching walls of the case 44 and include pluralities of locking holes 19a, 20a into which corresponding locking pieces 46a, 48a are inserted such that the locking pieces 46a, 48a are locked on circumferential edges of the locking holes 19a, 20a (refer to FIG. 3).

In addition, the accommodation space S of the folded airbag 51 in the column cover 16 is set such that left and right sides are surrounded by the left door portion 28 and the right door portion 29 of the door portion 26, the auxiliary left door portion 32 and the auxiliary right door portion 33, longitudinal sides are surrounded by the side walls 46, 48 of the case 44, an upper side is surrounded by a ceiling wall 45 of the case 44, and a lower side is surrounded by the lower door portion 27 and the auxiliary lower door portion 31 (refer to FIGS. 2 and 3).

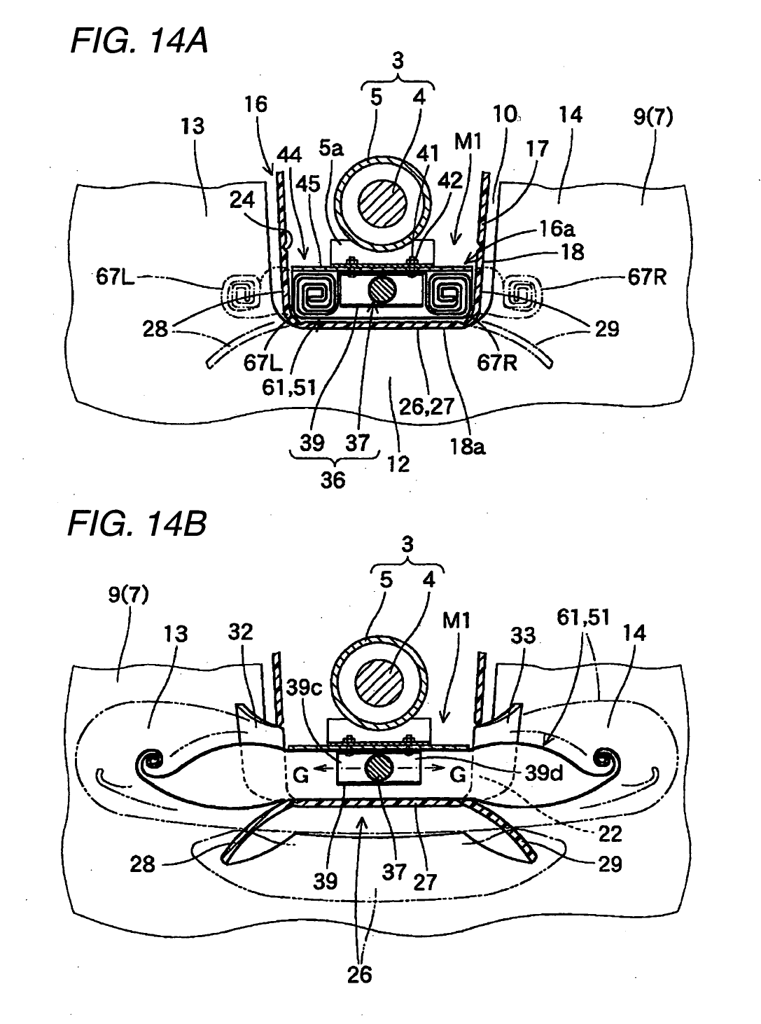

As is shown in FIGS. 2 to 4, the inflator 36 is made up of a main body 37 having a plurality of gas discharge ports 38a for discharging an inflation gas therethrough, and a diffuser 39 for restricting a flowing direction of the inflation gas discharged from the gas discharging ports 38a. The main body 37 is formed into a substantially cylindrical configuration having at a distal end thereof a cylindrical head portion 38 on an outer circumferential surface of which the plurality of gas discharge ports 38a are provided. In the case of this embodiment, the inflator 36 is disposed substantially along the longitudinal direction so as to extend along the axial direction O of the steering column 3 and the head portion 38 is provided at a rear end side of the inflator 36. The diffuser 39 is designed to cause the inflation gas G discharged from the gas discharging ports 38a to flow towards both left and right sides, that is, towards a left door portion 28 side and a right door portion 29 side of the column cover 16. In the case of this embodiment, the diffuser 39 is formed of a sheet metal into substantially a quadrangular tubular configuration which is made to open at both ends thereof with its axial direction made to follow the transverse direction. A circularly opened assembling hole 40 is formed in the vicinity of a transverse center of a front wall 39a of the diffuser 39 such that a head portion 38 side of the main body 37 is inserted thereinto. In addition, two bolts 41 are provided in parallel along the transverse direction on a ceiling wall 39b of the diffuser 39 so as to project upwards. In the case of this embodiment, the diffuser 39 is accommodated within the airbag 51 and the airbag 51 and the inflator 36 are attached to the case 44 by causing the respective bolts 41 which are caused to project from attaching holes 55, which will be described later, in the airbag 51 to project from the ceiling wall 45, which will be described later, of the case 44 so as to be fastened to a bracket 5a provided on the column tube 5 with nuts 42 (refer to FIGS. 2 and 14A). In addition, in the case of this embodiment, by the bolts 41 being fastened to the bracket 5a with the nuts 42, the knee protection airbag system M1 is made to be coupled to the column tube 5 to thereby be coupled to a body side of the vehicle.

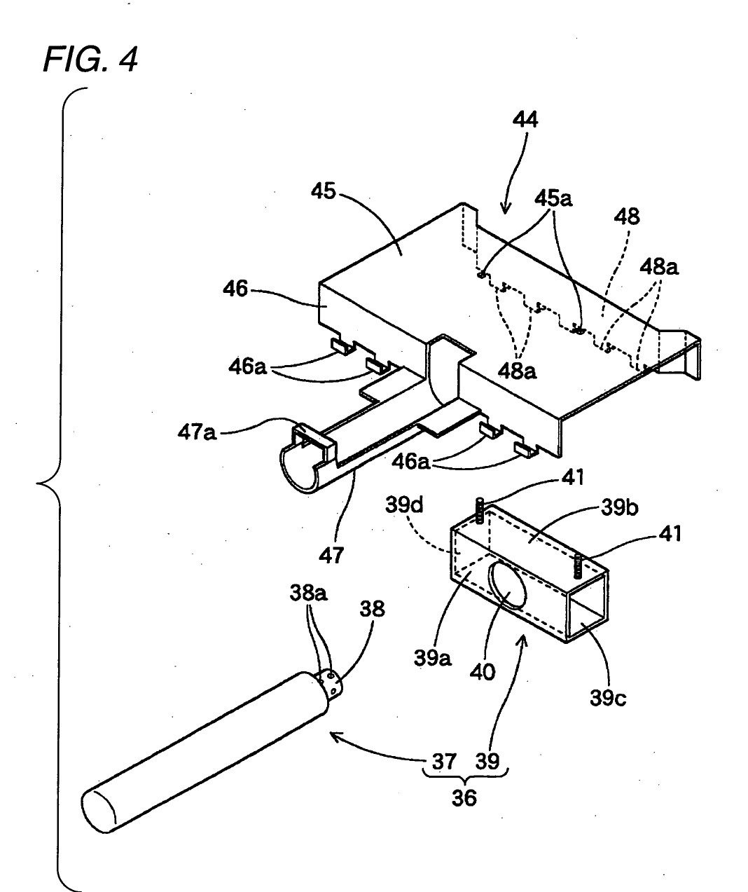

As is shown in FIGS. 2 and 4, the case 44 is formed of a sheet metal into a configuration having an inverted U-shaped cross section and is made up of the ceiling wall 45 and side walls 46, 48 which extend downwards from front and rear edges of the ceiling wall 45. The pluralities of locking pieces 46a, 48a of a substantially J-shaped cross section are formed respectively in the side walls 46, 48 so as to be inserted respectively into the locking holes 19a, 20a provided in the side walls 19, 20 of the column cover 16 so as to be coupled to the side walls 19, 20 (refer to FIGS. 2 to 4). Through holes 45a are formed in the ceiling wall 45 such that the respective bolts 41 of the inflator 36 are passed therethrough.

In addition, as is shown in FIG. 4, the front side wall 46 of the case 44 is separated in the vicinity of a transverse center thereof, and an attaching seat 47 where the main body 37 of the inflator 36 is fixed to the case 44 is formed in the position where the side wall 46 is so separated. The attaching seat 47 is formed substantially into a longitudinally half-cut cylindrical or semi-cylindrical configuration which is disposed such that its axial direction extends in the axial direction O of the steering column 3, that is, so as to extend substantially along the longitudinal direction so that the main body 37 can be accommodated with its head portion 38 inserted between the side walls 46, 48. Specifically, the attaching seat 47 is formed substantially into semi-cylindrical configuration so as to cover a lower half of the main body 37. In addition, a clamp portion 47a for fixing the main body 37 to the attaching seat 47 is provided at a front end side of the attaching seat 47. This clamp portion 47a is made to fix the main body 37 to the attaching seat 47 by being plastically deformed so as to be brought into press contact with an outer circumferential surface of the main body 37 by being reduced diametrically.

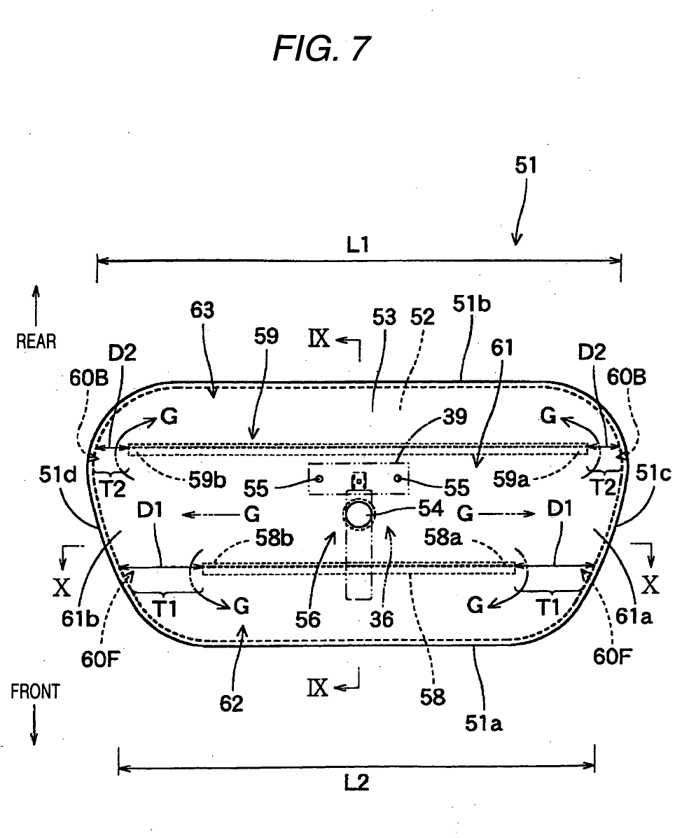

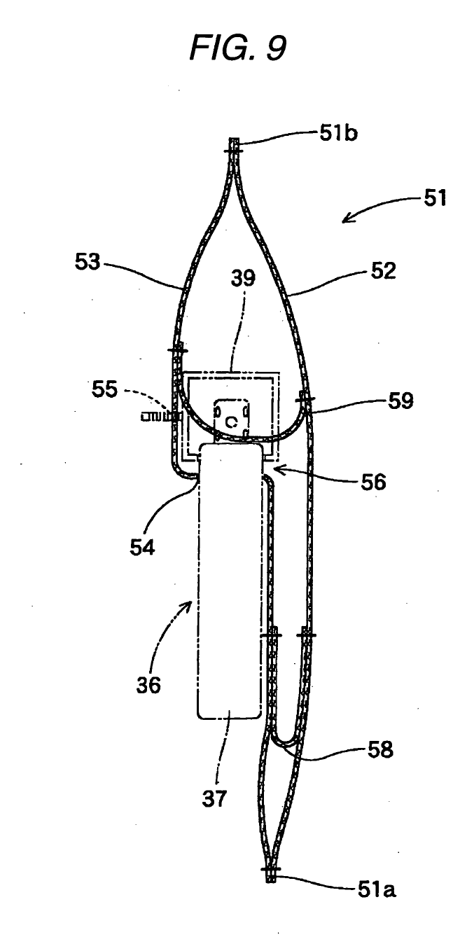

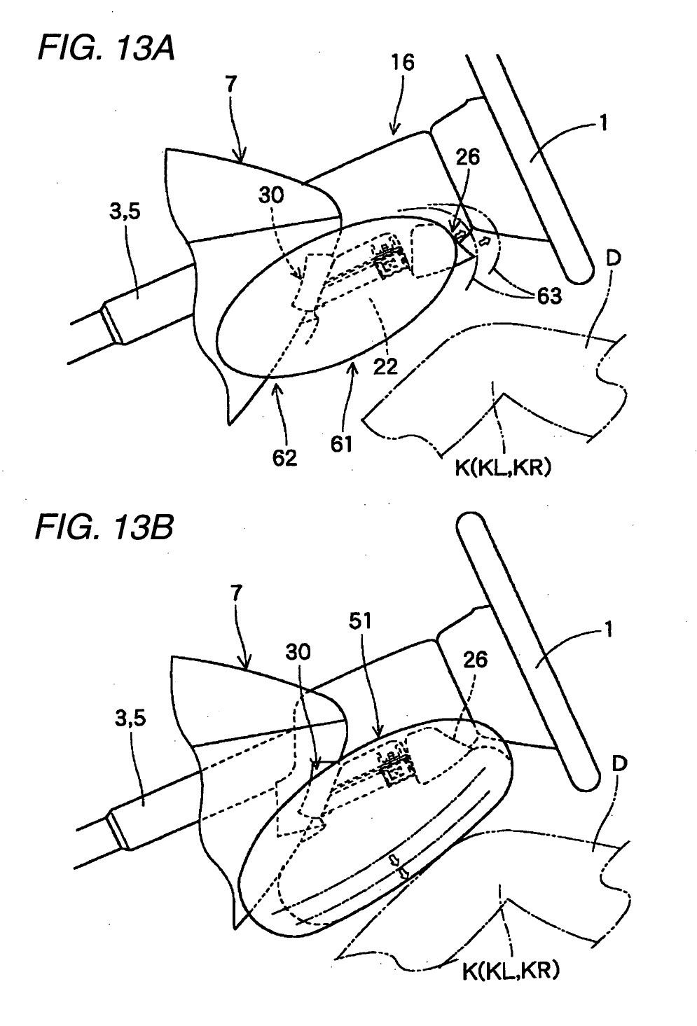

The airbag 51 is configured to have a transversely elongated substantially rectangular configuration in which its transverse direction is elongated longer than its longitudinal direction as a configuration resulting when it is completely inflated so as to be able to protect both the knees K (KL, KR) of the driver D. More specifically, the airbag 51 is formed to have as a configuration resulting when the airbag 51 is completely inflated a transversely symmetrical trapezoidal configuration in which a transverse width dimension L1 on a rear edge 51b side is made larger while a transverse width dimension L2 of a front edge 51a side is made smaller when the airbag 51 is completely inflated such that its transverse width dimension gets narrower as it extends towards the front edge 51a side (refer to FIGS. 7 to 10). In addition, the airbag 51 is provided so as to extend substantially along the longitudinal direction so as to extend along the lower surface 18a of the column cover 16 when it is completely inflated and is made to be disposed at a front side of the knees K (KL, KR) of the driver D in the longitudinal direction of the vehicle while covering the lower surface 18a side of the column cover 16 and the rear surfaces 12, 13, 14 of the instrument panel 7 which lie to correspond to an area on the column cover 16 expanding from the lower side to both the left and right or transverse sides thereof when it is completely inflated (refer to FIGS. 13B, 15B and 16). As is shown in FIGS. 7 to 10, the airbag 51 is made up of a driver-side wall portion 52 which is disposed on a lower surface side which constitutes a driver D side and a column-side wall portion 53 which is disposed on an upper side which constitutes a column cover 16 side when the airbag is completely inflated. These driver-side wall portion 52 and column-side wall portion 53 are made of a woven fabric having flexibility such as polyester threads or polyamide threads, and in the case of this embodiment, the airbag 51 is made into a flat bag which is made by sewing (joining) together outer circumferential edges of the driver-side wall portion 52 and the column-side wall portion 53 which are formed to have the same substantially trapezoidal configurations.

An insertion hole 54, which is opened circularly for insertion of the rear end side (the head portion 38 side) of the main body 37 of the inflator 36, is formed in the vicinity of a longitudinally and transversely center of the column-side wall portion 53 when the airbag 51 is completely inflated. This insertion hole 54 is formed in a position which corresponds to the assembling hole 40 formed in the front wall 39a of the diffuser 39 when the diffuser 39 of the inflator 36 is accommodated in an interior of the airbag 51. In addition, the attaching holes 55 are formed on both left- and right-hand sides of the insertion hole 54 in the column-side wall portion 53 such that the bolts 41 of the diffuser 39 are allowed to project therethrough. In the case of this embodiment, as has been described before, the airbag 51 is installed in the vehicle with the diffuser 39 inserted into the interior thereof, and as is shown in FIG. 3, an area of the airbag 51 where the diffuser 39 is provided, that is, an area of the airbag 51 which lies in the vicinity of the longitudinally and transversely center thereof when the airbag 51 is completely inflated where the insertion hole 54 and the attaching holes 55 are disposed constitutes an inlet port portion 56 which is connected to the inflator 36 such that the inflation gas G from the inflator 36 is allowed to flow into the interior of the airbag 51.

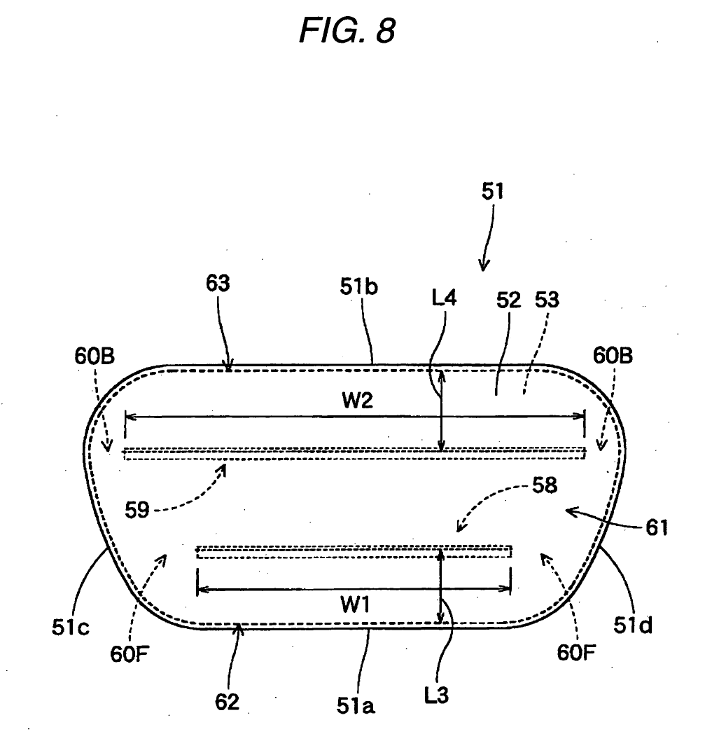

As is shown in FIGS. 7 to 10, a front tether 58 and a rear tether 59 are provided within the airbag 51, and the front tether and the rear tether 59 are made to be coupled to the driver-side wall portion 52 and the column-side wall portion 53 so as to restrict the thickness of the airbag 51 when it is completely inflated. The front tether 58 and the rear tether 59 are each formed to have a belt-like configuration in which their longitudinal direction is made to extend along the transverse direction, and their transverse edges are sewed both the driver-side wall portion 52 and the column-side wall portion 53. Thus, the front tether 58 and the rear tether 59 are provided so as to extend substantially along the transverse direction in positions which lie on front and rear or longitudinal sides of the inlet port portion 56, so that gaps are provided between a left edge 51c and a right edge 51d of the airbag 51. In the case of this embodiment, a transverse width dimension W1 of the front tether 58 is made smaller than a transverse width dimension W2 of the rear tether 59 (refer to FIG. 8). Furthermore, in the airbag 51 of this embodiment, the rear tether 59 is configured such that a sewed portion to the driver-side wall 52 is offset further forwards than a sewed portion to the column-side wall 53. Namely, for the inflator 36 (the diffuser 39) to be accommodated in the airbag 51, the rear tether 59 is provided within the airbag 51 such that the sewed portion to the column-side wall portion 53 is offset further rearwards than the sewed portion to the driver-side wall portion 52. In addition, in the case of the embodiment, in such a state that they are viewed from a lower side (a column-side wall portion 53 side) of the airbag, front tether 58 and the rear tether 59 are provided in positions where they divide the airbag 51 into three portions along the longitudinal direction of the airbag 51 (refer to FIG. 8). Namely, in the airbag 51 of this embodiment, a distance L3 from a front edge 51a of the front tether 58 is made to be substantially equal to a distance L4 from a rear edge 51b of the rear tether 59 (refer to FIG. 8).

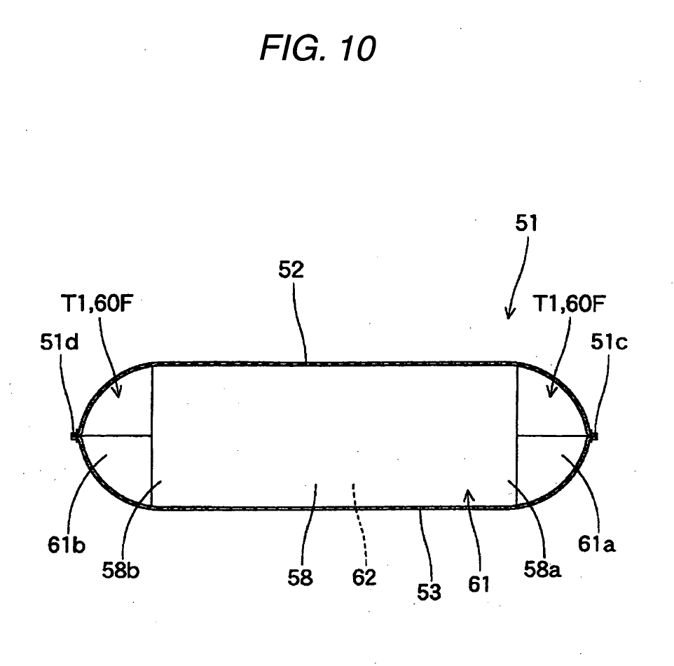

Furthermore, in the embodiment, the airbag 51 takes a form in which the airbag 51 is divided by the front tether 58 and the rear tether 59 so as to be made up of a central portion 61 which is made up of an area surrounded by the front tether 58 and the rear tether 59, a front portion 62 which is made up of an area lying forwards of the front tether 58 and a rear portion 63 which is made up of an area lying rearwards of the rear tether 59. In addition, in the case of the embodiment, gaps T1, T2 which are formed between transverse end portions 58a, 58b, 59a, 59b of the front tether 58 and the rear tether 59 and the left edge 51c and the right edge 51d of the airbag 51 constitute outlet path portions 60F, 60B through which the inflation gas is caused to flow from the central portion 61 into the front portion 62 and the rear portion 63 (refer to FIGS. 7 and 10).

In this embodiment, as is shown in FIG. 7, opening width dimensions D1 of the gaps T1 defined between end portions 58a, 58b of the front tether 58 and the left edge 51c and the right edge 51d of the airbag 51 are set larger than opening width dimensions D2 of the gaps T2 defined between end portions 59a, 59b of the rear tether 59 and the left edge 51c and the right edge 51d of the airbag 51 so that the outlet path portions 60F which allow the inflation gas G to flow into the front portion 62 therethrough is made larger in a total sum of open areas than the outlet path portions 60B which allow the inflation gas G to flow into the rear portion 63 therethrough. Specifically, in order for the front portion 62 to be inflated more quickly than the rear portion 63, the total sum of open areas of the outlet path portions 60F is desirably set double or more the open areas of the outlet path portions 60B, and in the case of this embodiment, the open area ratio of the outlet path portions 60F to the outlet path portions 60B is set to 2 to 1. In addition, as has been described before, the airbag 51 is formed into the substantially trapezoidal shape in which the transverse width dimension L1 on the rear edge 51b side is made larger while the transverse width dimension L2 on the front edge 51 side is made smaller. In other words, the airbag 51 is configured such that a transverse width dimension of the front portion 62 is made smaller than a transverse width dimension of the rear portion 63. Furthermore, the airbag 51 is configured such that the distance L3 from the front edge 51a of the front tether 58 is made substantially equal to the distance L4 from the rear edge 51b of the rear tether 59. In other words, the airbag 51 is configured such that a longitudinal width dimension of the front portion 62 becomes substantially equal to a longitudinal width dimension of the rear portion 63. Namely, in the airbag 51 of this embodiment, the volume of the front portion 62 is made smaller than the volume of the rear portion 63.

In addition, in this embodiment, the inflation gas G which has been discharged from the gas discharge ports 38a and flowed into the interior of the airbag 51 by way of openings 39c, 39d at transverse ends of the diffuser 39 is rectified by the front tether 58 and the rear tether 59 as is indicated by chain double-dashed lines in FIG. 7 to flow in the central portion 61 towards transverse end portions 61a, 61b thereof. Thereafter, the inflation gas G flows into the front portion 62 and the rear portion 63 by way of the outlet path portions 60F, 60B which are provided at the transverse end portions 61a, 61b of the central portion 61. In this embodiment, the inflation gas G which flows into the front portion 62 and the rear portion 63 by way of the outlet path portions 60F, 60B is made to flow into the front portion 62 and the rear portion 63 such that its flowing direction is turned over to be directed towards a transverse center of each portion. In addition, in the airbag 51 of this embodiment, a knee protection area for protecting the knees K (KL, KR) of the driver D is made up of an area which comes to be disposed on the left and right or transverse sides of the column cover 16 when the airbag 51 is completely inflated, which is an area expanding from the vicinity of the rear tether 59 in the rear portion 63 to the front portion 62 (refer to FIGS. 15B and 16).

Installation work of the knee protection airbag system M1 of the first embodiment in the vehicle will be described. Firstly, the airbag 51 is folded. In the case of this embodiment, the folding of the airbag 51 is implemented through two steps including a longitudinal contraction folding in which the airbag 51 is folded from a state in which the driver-side wall portion 52 and the column-side wall portion 53 are deployed flat and are then superposed one on the other so as to decrease the longitudinal width dimension so as to be accommodated in the case 44 and a transverse contraction folding in which the airbag 51 is folded so as to decrease the transverse width direction thereof.

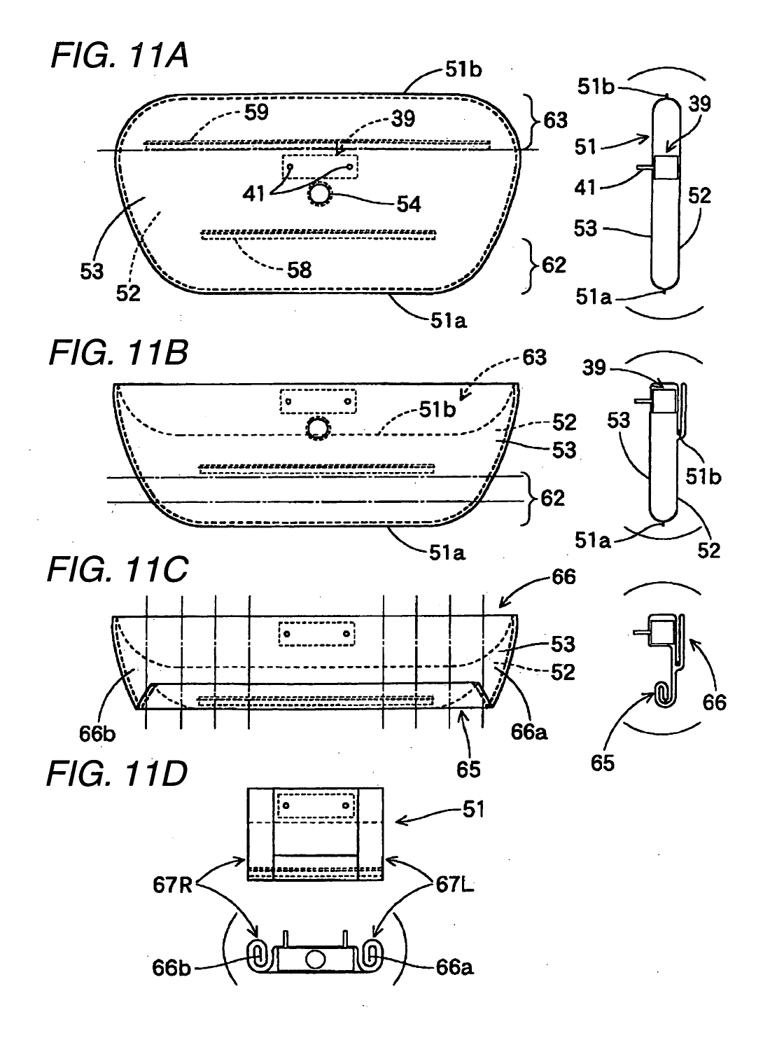

Specifically, in such a state that the diffuser 39 is accommodated in the interior of the airbag 51 in advance such that the bolts 41 are made to project from the attaching holes 55, the airbag 51 is firstly folded through the longitudinal contraction folding in which the longitudinal width dimension of the airbag 51 is decreased so as to be accommodated within the case 44 from the state in which the driver-side wall portion 52 and the column-side wall portion 53 are deployed flat. To describe this in details, as is shown in FIGS. 11A to 11C, from the state in which the driver-side wall portion 52 and the column-side wall portion 53 are deployed flat, the longitudinal contraction folding is implemented in which the area of the rear portion 63 is folded along the transverse direction in the vicinity of the rear tether 59 and is then folded further into the interior of the airbag 51 while causing the rear edge 51b to approach the front edge 51a side and then, the area of the front portion 62 is folded into a roll towards the column-side wall portion 53 so as to form a roll-folded portion 65. Thereafter, the transverse contraction folding is implemented in which the transverse width dimension of the airbag 51 is decreased so as to be accommodated within the case 44. To describe this in detail, as is shown in FIGS. 11C and 11D, a left edge 66a and a right edge 66b of the airbag 66 which has been folded through the longitudinal contraction folding are folded into a roll towards the column-side wall portion 53 so as to form roll-folded portions 67L, 67R, whereby the airbag 51 can be folded as designed. In addition, although not shown, when the folding of the airbag 51 is completed, the insertion hole 54 formed in the column-side wall portion 53 comes to be disposed in a position which substantially coincides with the assembling hole 40 in the diffuser 39.

In addition, when the airbag 51 is completely folded, the airbag 51 is wrapped by a predetermined unfolding preventive wrapping material so as to prevent the unfolding of the folded airbag 51. As this occurs, the bolts 41 and the insertion hole 54 (the assembling hole 40) are left exposed from the wrapping material. Following this, the folded airbag 51 is accommodated in the portion in the case 44 which is defined between the side walls 46, 48 of the case 44 while causing the bolts 41 of the diffuser 39 to pass through the through holes 45a in the ceiling wall 45. Then, the main body 37 of the inflator 36 is disposed on an upper surface side of the attaching seat 47, and the head portion 38 side of the main body 37 is inserted into the insertion hole 54 in the airbag 51 and is further inserted into the assembling hole 40 in the diffuser 39. Furthermore, the clamp portion 47a is plastically deformed so as to be decreased diametrically, and the main body 37 is assembled on to the diffuser 39 to form the inflator 36. As this occurs, the inflator 36 not only can be coupled to the airbag 51 but also can be fixed to the case 44, whereby an airbag assembly can be assembled up.

Then, the airbag assembly that has been assembled in the way described above is fixedly attached to the bracket 5a provided on the column tube 5 of the steering column 3 by fastening the bolts 41 with the nuts 52. Then, a lead wire, not shown, which is extended from an airbag activation circuit is connected to the main body 37 of the inflator 36, and the column cover 16 is attached to the steering column 3, whereby the knee protection airbag system M1 can be installed in the vehicle.

In the knee protection airbag system M1 of the first embodiment, after the system M1 has been installed in the vehicle, when an activation signal is inputted into the main body 37 of the inflator 36, the inflation gas G is discharged from the gas discharge ports 38a provided in the head portion 38 of the main body 37. Then, inflation gas G is allowed to flow into the airbag 51 via the openings 39c, 39d at the transverse ends of the diffuser 39. Thereafter, the airbag 51 being inflated projects downwards from the projecting opening 22 formed by the door portion 26 and the auxiliary door portion 30 on the column cover 16 being push opened by the airbag 51, whereby the airbag 51 completes its inflation as is shown by a chain double-dashed line in FIG. 1 and FIGS. 13B, 15B and 16.

As this occurs, in the knee protection airbag system M1 of the first embodiment, the inflation gas G which has flowed into the airbag 51 from the openings 39c, 39d at the transverse ends of the diffuser 39 by way of the inlet port portion 56 is guided as is indicated by the chain double-dashed lines in FIG. 7 by the front tether 58 and the rear tether 59 and then flows within the central portion 61 towards the transverse end portions 61a, 61b. Because of this, when the airbag 51 folded and accommodated projects downwards from the projecting opening 22 formed by the door portion 26 and the auxiliary door portion 30 of the column cover 16 being push opened by the airbag 51, firstly, as is shown in FIGS. 14A, 14B and 16, the airbag 51 is deployed and inflated so as to expand the central portion 61 transversely widely. As this occurs, the front portion 62 and the rear portion 63 are deployed widely in the transverse direction in association with the transverse deployment of the central portion 61 in such a state that the front portion 62 and the rear portion 63 are not inflated thick. In addition, thereafter, the inflation gas G is caused to flow into the front portion 62 and the rear portion 63 by way of the outlet path portions 60F, 60B which are provided at the transverse end portions 58a, 58b, 59a, 59b of the front tether 58 and the rear tether 59 from the transverse end portions towards the center, whereby the front portion 62 and the rear portion 63 are inflated thick as is shown in FIGS. 13B, 15B and 16 while being deployed widely in the longitudinal direction, the inflation of the airbag 51 being thereby completed.

Consequently, in the knee protection airbag system M1 of the first embodiment, since the airbag 51 which projects from the column cover 16 is deployed and inflated widely in the transverse direction in the initial stage of inflation and is then inflated smoothly so as to increase the thickness thereof, evening the event that the column cover 16 lies close to the knees K (KL, KR) of the driver D who is seated in the driver's seat, the airbag 51 can be inflated smoothly so as to be disposed at the front end of the knees K (KL, KR) of the driver D who is seated in the driver's seat.

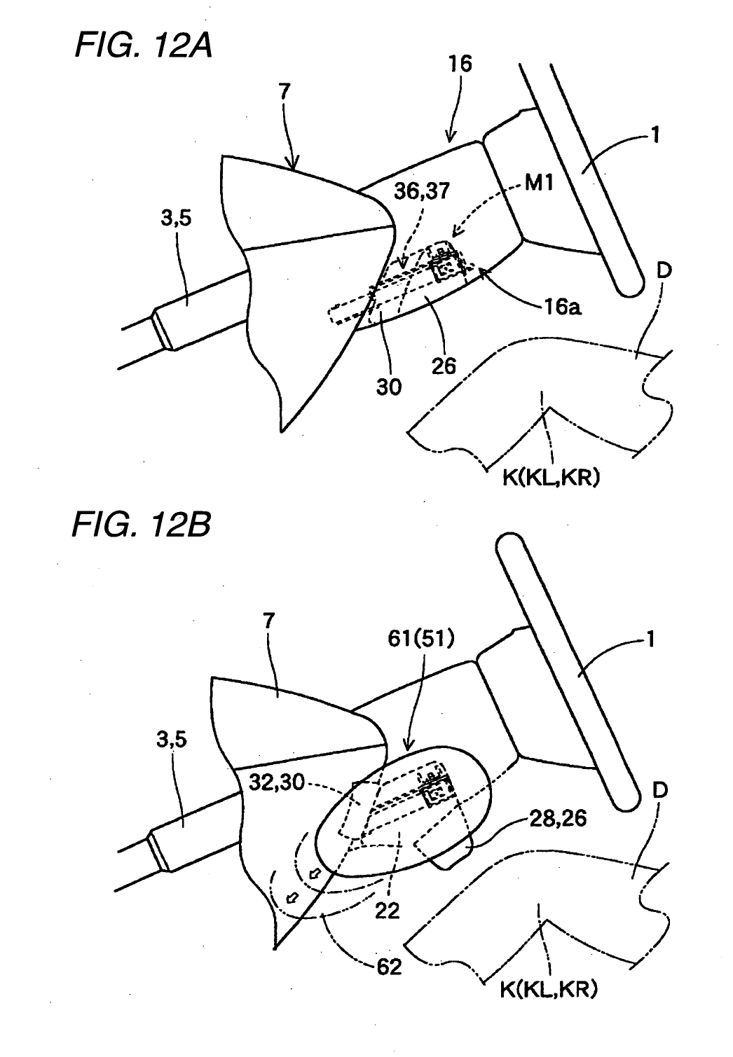

In addition, in the knee protection airbag system M1 of the first embodiment, since the outlet path portions 60F which allow the inflation gas G to flow out into the front portion 62 are made larger in a total sum of open areas than the outlet path portions 60B which allow the inflation gas G to flow out into the rear portion 63, the front portion 62 can be inflated more quickly than the rear portion 63. Namely, in the knee protection airbag system M1 of the first embodiment, as is shown in FIGS. 14B and 15A, the central portion 61 is deployed so as to be expanded largely in the transverse direction, and thereafter, as is shown in FIGS. 12B and 13A, the front portion 62 is deployed more quickly than the rear portion 63 and is then inflated so as to increase its thickness. Because of this, in the knee protection airbag system M1 of the first embodiment, since the front portion 62 of the airbag 51 which is situated at the side of the knees K (KL, KR) of the driver D which faces the traveling direction of the vehicle (at the front side in the longitudinal direction of the vehicle) can be inflated more quickly than the rear portion 63 by causing the inflation gas G to be introduced more quickly into the front portion 62 than into the rear portion 63, the front portion 62 can be inflated before the driver D is moved forwards, and even in the event that the driver D who is seated in the driver's seat is moved forwards with his or her knees disposed close to the column cover 16, the knees K (KL, KR) of the driver D can be received by the front portion 62 itself of the airbag 61 which has completed its inflation quickly or the central portion 61 which is inflated while being supported by the front portion 62 so inflated. As this occurs, the front portion 62 comes to be supported by the rear surfaces 12, 13, 14 of the instrument panel 7 which are disposed at the front of the vehicle.

Further, in the knee protection airbag system M1 of the first embodiment, since the airbag 51 is made to be formed into the substantially trapezoidal configuration in which the transverse width dimension thereof gets narrower as it extends towards the front edge 51a side as the external configuration thereof which results when the airbag 51 is inflated completely and the volume of the front portion 62 is made smaller than the volume of the rear portion 63, the front portion 62 can preferably be inflated much more quickly than the rear portion 63. Of course, unless a point like this is taken into consideration, an airbag may be adopted in which the airbag is formed into a substantially rectangular configuration in which the transverse width dimension remains constant along the longitudinal direction thereof as an external configuration of the airbag resulting and a front portion and a rear portion have the same volume when the airbag is inflated completely.

Furthermore, in the knee protection airbag system M1 of the first embodiment, the airbag 51 is folded from the state in which the driver-side wall portion 52 and the column-side wall portion 53 are deployed flat and are then superposed one on the other for accommodation through the longitudinal contraction folding in which the airbag 51 is folded so as to decrease the longitudinal width dimension and thereafter the transverse contraction folding in which the airbag 51 is folded so as to decrease the transverse width dimension, and the transverse contraction folding is made up of the roll folding in which the left and right or transverse end portions (the left edge 66a and the right edge 66b of the airbag 66 which has been subjected to the longitudinal contraction folding) are rolled towards the column-side wall portion 53. Because of this, in the knee protection airbag system M1 of the first embodiment, the airbag 51, into the interior of which the inflation gas G is caused to flow to thereby be allowed to project outwards from the column cover 16, is firstly deployed widely in the transverse direction (refer to FIGS. 14B and 15A) along the rear surfaces 13, 14 of the instrument panel 7 in such a manner as unfold the roll folded portions 67L, 67R which are folded through the transverse contraction folding, and thereafter, is deployed so as to be expanded longitudinally. Because of this, in the initial stage of inflation, the airbag can be deployed widely in the transverse direction more quickly. In addition, in the first embodiment, in the transverse contraction folding, since the left and right or transverse edge portions (the left edge 66a and the right edge 66b of the airbag 66 which has been subjected to the longitudinal contraction folding) are individually roll folded so as to be rolled towards the column-side wall portion 53 side, when unfolding the transverse contraction folding, the respective roll folded portions 67L, 67R are deployed along the rear surfaces 13, 14 of the instrument panel 7 so as to unfold the folds, and the occurrence of a deployment of the airbag so as to project towards the driver's side can be suppressed as much as possible.

In addition, in the first embodiment, in the longitudinal contraction folding, the area of the rear portion 63 is folded along the transverse direction in the vicinity of the rear tether 59 and is folded further into the interior of the airbag 51 while the rear edge 51b is made to approach the front edge 51a side, and the area of the front portion 62 is folded through roll folding so as to roll the front edge 51a towards the column-side wall portion 53. Because of this, when the central portion 61 is deployed widely in the transverse direction while unfolding the folds at the roll folded portions 67L, 67R and thereafter the front portion 62 is deployed while unfolding the fold by way of the outlet path portions 60F, due to the front portion 62 being roll folded such that the front edge 51a is rolled towards the column-side wall portion 53 side, the front portion 62 is deployed along the lower surface 18a of the outer circumferential surface 18 of the column cover 16 and the rear surfaces 12, 13, 14 of the instrument panel 7 while unfolding the fold at the roll folded portion 65, and as this occurs, the projection of the front portion 62 towards the driver D side is suppressed as much as possible. In addition, since the rear portion 63 is also folded into the interior of the airbag 51 while causing the rear edge 51b to approach the front edge 51a side, the rear portion 63 is deployed so as to project rearwards along the lower surface 18a of the outer circumferential surface 18 of the column cover 16 as is indicated by a chain double-dashed line in FIG. 16. Because of this, when the airbag 51 is deployed and inflated, the area of the rear portion 63 can be inflated smoothly while suppressing the interference with the column cover 16 and preventing the projection of the rear portion 63 towards the driver D side as much as possible.

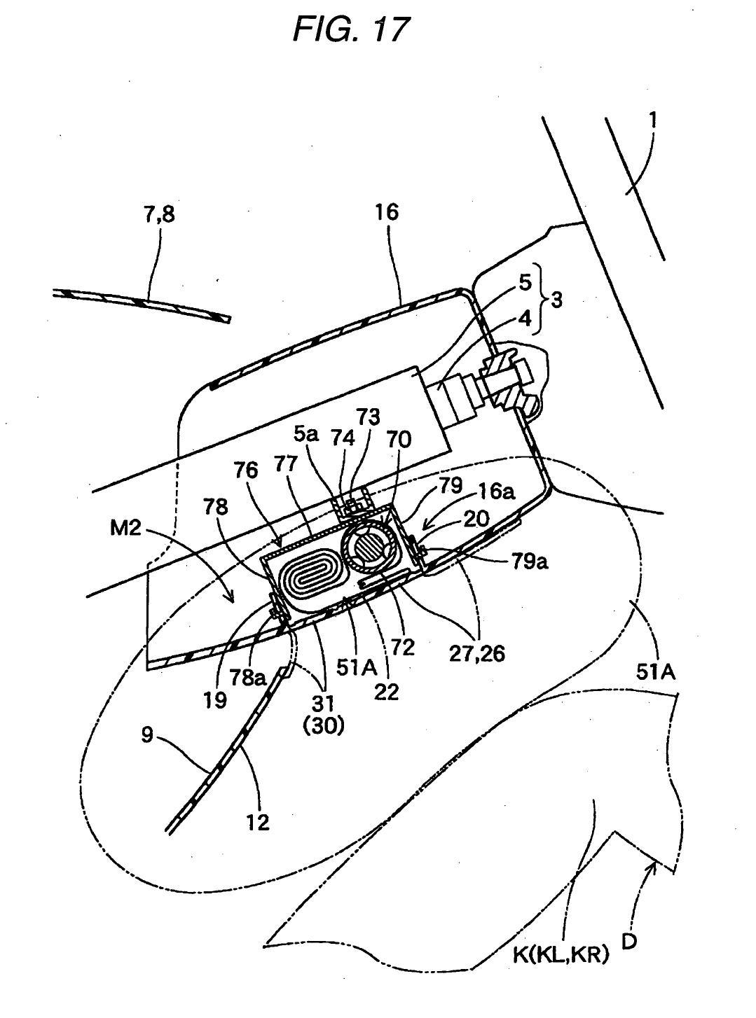

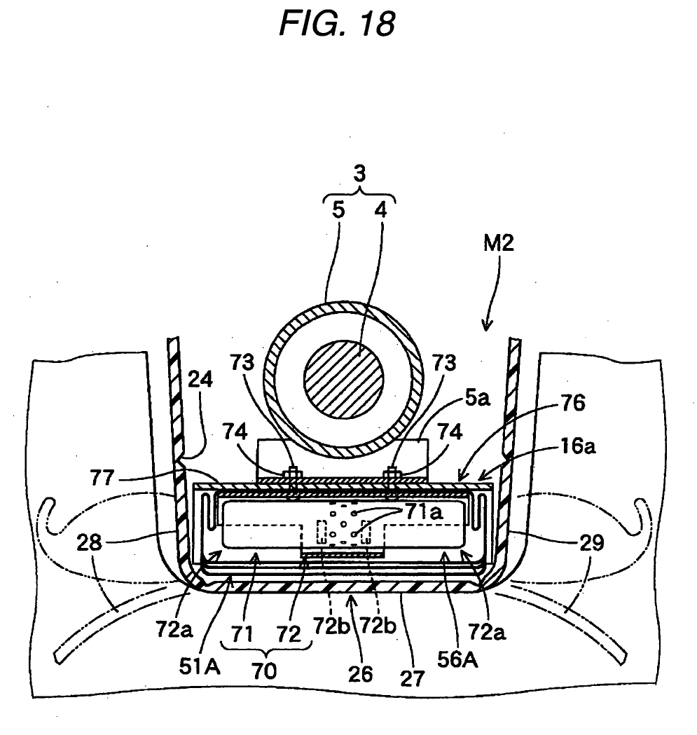

Next, a knee protection airbag system M2 according to a second embodiment will be described below. As is shown in FIGS. 17 and 18, the knee protection airbag system M2 is similar to the knee protection airbag system M1 of the first embodiment that has been described above in a configuration in which the knee protection airbag system M2 is made up of an airbag 51A and an inflator 70 which are accommodated at a lower portion 16a inside a column cover 16, and is made up of the airbag 51A, the inflator 70 and a case 76 which accommodates therein the airbag 51A and the inflator 70. The configuration of the knee protection airbag system M2 of the second embodiment is substantially similar to the configuration of the knee protection airbag system M1 of the first embodiment except for the fact that the orientation of a main body 71 of the inflator 70 is different from that of the first embodiment, and the column cover 16 has the same configuration as that described in the first embodiment. Thus, like reference numerals will be imparted to like members, and the description thereof will be omitted.

As is shown in FIGS. 17 and 18, the inflator 70 is made up of the substantially cylindrical main body 71 having a plurality of gas discharge ports 71a for discharging an inflation gas therethrough and a retainer 72 made of a sheet metal for holding the main body 71 so as to fixedly attach the airbag 51A to the case 76. When installed in a vehicle, the main body 71 is disposed such that its axial direction is made to extend along a transverse direction which intersects an axial direction O of a steering column 3 at right angles and is configured such that the plurality of gas discharge ports 71a re provided in a transverse center thereof. The retainer 72 is formed substantially into a cylindrical configuration with its axial direction oriented along the transverse direction, and two bolts 71a which project upwards are provided in parallel along the transverse direction. Left and right or transverse end sides of the retainer 72 constitute openings 72a from which the inflation gas discharged from the gas discharge ports 71a is caused to flow outwards of left and right sides of the retainer 72. In the case of the embodiment, lower surface sides of left and right end portions of the retainer 72 are each cutaway so as to be formed into a semi-cylindrical configuration which covers only an upper surface side of the main body 71. In addition, holding portions 72b are formed in the vicinity of a transverse center of the retainer 72 so as to be decreased diametrically so as to hold the main body 71 when the main body 71 is inserted into the retainer 72.

In the second embodiment, the bolts 73 of the retainer 72 are caused to project from attaching holes 55A of the airbag 51A and are then caused to project from a ceiling wall 77, which will be described later, of the case 76 so as to be fastened to a bracket 5a provided on a column tube 5 with nuts 74, whereby the airbag 51A and the inflator 70 are attached to the case 76. In addition, also in the second embodiment 2, by the bolts 73 being fastened to the bracket 5a with the nuts 74, the knee protection airbag system M2 is coupled to the column tube 5 and is then coupled to a body side of the vehicle.

The case 76 is configured so as to accommodate therein the folded airbag 51A and the inflator 70 and is formed of a sheet metal into a configuration having an inverted U-shaped cross section. The case 76 is made up of a ceiling wall 77 and side walls 78, 79 which extend downwards from front and rear edges of the ceiling wall portion 77. As with the side walls 46, 48 of the case 44 in the first embodiment, the respective side walls 78, 79 have pluralities of locking pieces 78a, 79a of a substantially J-shaped cross section which are formed so as to be inserted into corresponding locking holes 19a, 20a which are provided in side walls 19, 20 of the column cover 16 so as to be coupled to the side walls 19, 20 (refer to FIG. 17). Through holes (whose reference numeral is omitted) through which the respective bolts 73 of the inflator 70 are to be passed are formed in the ceiling wall 77.

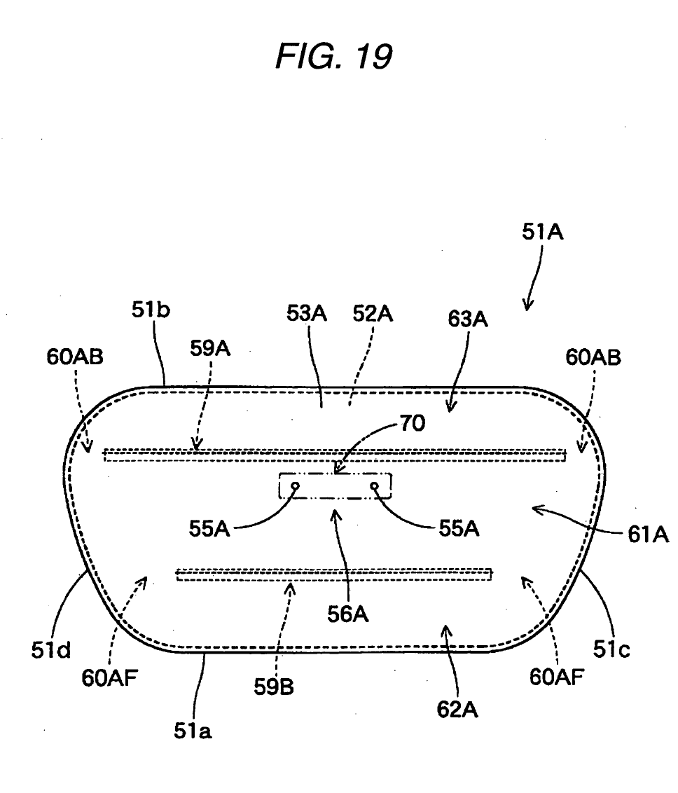

As is shown in FIG. 19, the airbag 51A has the same configuration as that of the airbag 51 described in the first embodiment except for the fact that an insertion hole into which the main body of the inflator is to be inserted is not formed. Therefore, a character “A” is appended to the end of like reference numerals given to like members to those of the first embodiment and the description thereof will be omitted. In the knee protection airbag system M2 of the second embodiment, as is shown in FIGS. 17 and 18, the airbag 51A is such as to be installed in the vehicle with the inflator 70 inserted thereinto, and as is shown in FIG. 18, an area where the inflator 70 is provided or an area lying in the vicinity of a longitudinal and transverse center of the airbag which results when it is fully inflated and where the attaching holes 55 are disposed constitutes an inlet port portion 56A which is connected to the inflator 70 for allowing the inflation gas G from the inflator 70 to flow into an interior of the airbag.

Next, installation work of the knee protection airbag system M2 of the second embodiment in the vehicle will be described. Firstly, the airbag 51A is folded. In the second embodiment, the airbag 51 is folded from a state in which a driver-side wall portion 52A and a column-side wall portion 53A are deployed flat and are then superposed one on the other through a preliminary folding, a transverse contraction folding in which a transverse width dimension of the airbag 51A is decreased, and a longitudinal contraction folding in which a longitudinal width dimension of the airbag 51A is decreased such that the airbag 51A can be accommodated within the case 76. Namely, in the second embodiment, the airbag 51A is folded through the three steps including the preliminary folding, the transverse contraction folding and the longitudinal contraction folding.

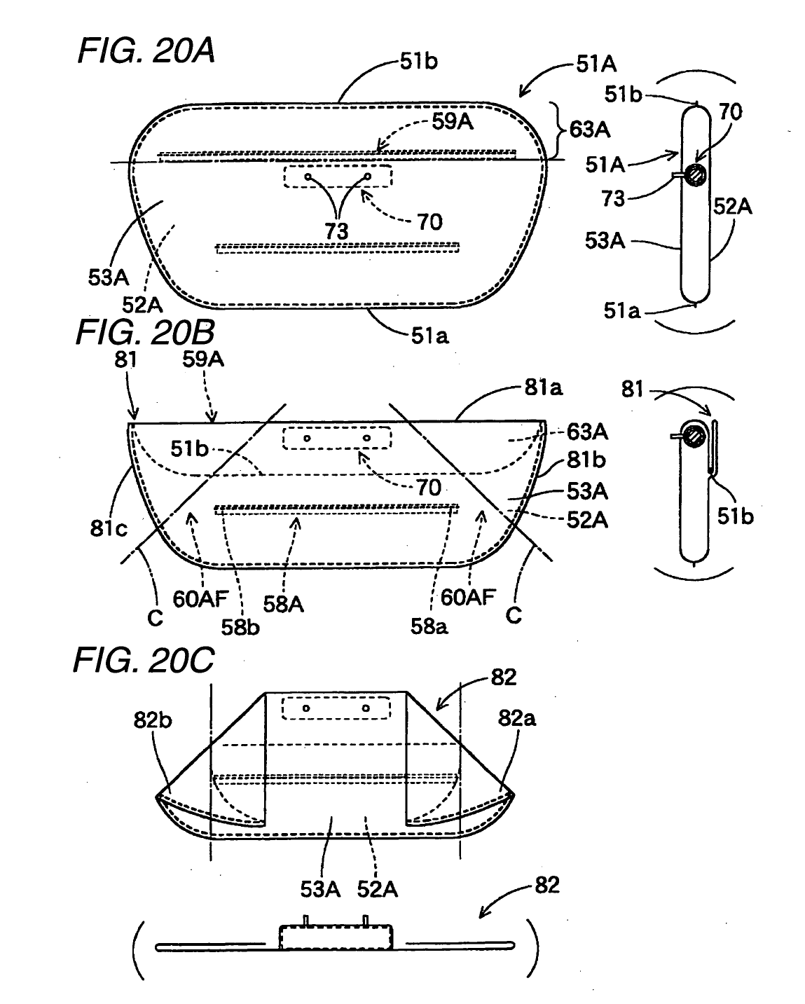

Specifically, firstly, in such a state the inflator 70 is accommodated within the interior of the airbag 51A so as to allow the bolts 73 to project from the attaching holes 55A, the preliminary folding is implemented from the state in which the driver-side wall portion 52A and the column-side wall portion 53A are deployed flat. To describe this in detail, as is shown in FIG. 20A, an area of a rear portion 63A is folded along the transverse direction in the vicinity of a rear tether 59 from the state in which the driver-side wall portion 52A and the column-side wall portion 53A are deployed flat and is folded further into the interior of the airbag 51A so as to cause a rear edge 51b to approach a front edge 51a side. The, left and right or transverse end portions 81b, 81c (left and right or transverse end portions of the rear tether 59A) of a rear edge 81a of the airbag 81 resulting from the folding made above are folded individually so as to create a fold C which intersects the transverse direction as is shown in FIGS. 20B and 20C and are then folded back towards the column-side wall portion 53A side, whereby the preliminary folding is completed. The intersecting folds C are formed so as to intersect only the rear tether 59A and not to intersect a front tether 58A. In other words, the intersecting folds C are disposed within outlet path portions 60AF which are spaced apart from left and right or transverse end portions of the front tether 58. In addition, the two intersecting folds C are disposed to form substantially side edges of an unfolded fan which are spaced apart from each other as they extend forwards when the flat deployed airbag 51A is viewed from the column-side wall portion 53A side.

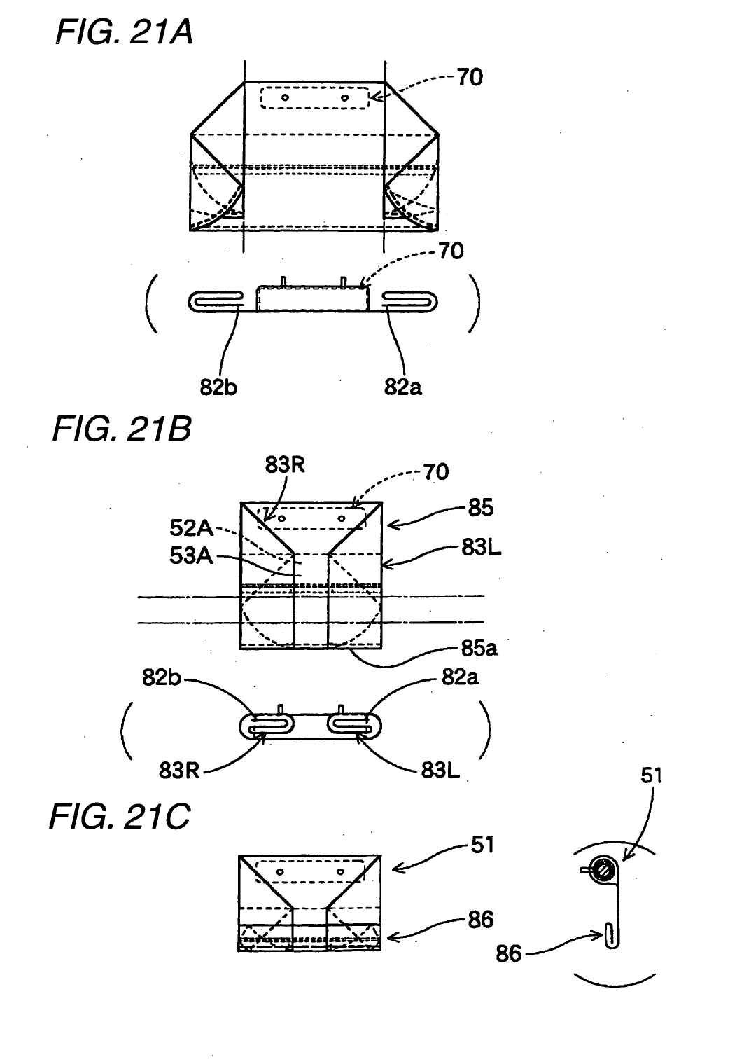

Thereafter, the transverse contraction folding is implemented on the preliminarily folded airbag 82 so as to decrease the transverse width dimension so as to be accommodated within the case 76. To describe this in detail, as is shown in FIGS. 20C, 21A and 21B, the transverse contraction folding is implemented such that a left edge 82a and a right edge 82b of the preliminarily folded airbag 82 are roll folded individually while being rolled towards the column-side wall portion 53A side, so as to form roll folded portions 83L, 83R. Following this, the longitudinal contraction folding is implemented so as to decrease the longitudinal width dimension of the airbag 51A so that the airbag 51A can be accommodated within the case 76. To describe this in detail, as is shown in FIGS. 21B and 21C, the longitudinal contraction folding is implemented such that an area corresponding to a front portion 62A of the transversely folded airbag 85 is roll folded in such a way that a front edge 85a is rolled towards the column-side wall portion 53A side, so as to form a roll folded portion 86, whereby the airbag 51A can be folded to be accommodated within the case 76.

Then, when the folding of the airbag 51A is completed, as has been described in the first embodiment, the airbag 51A is wrapped with a predetermined unfolding preventive wrapping material, and the volts 73 of the retainer 72 which project from the airbag 51A are passed through the through holes in the ceiling wall 77. Then, the airbag 51A so folded up is accommodated together with the inflator 70 in a portion defined between the side walls 78, 79 of the case 76, whereby an airbag assembly is assembled up.

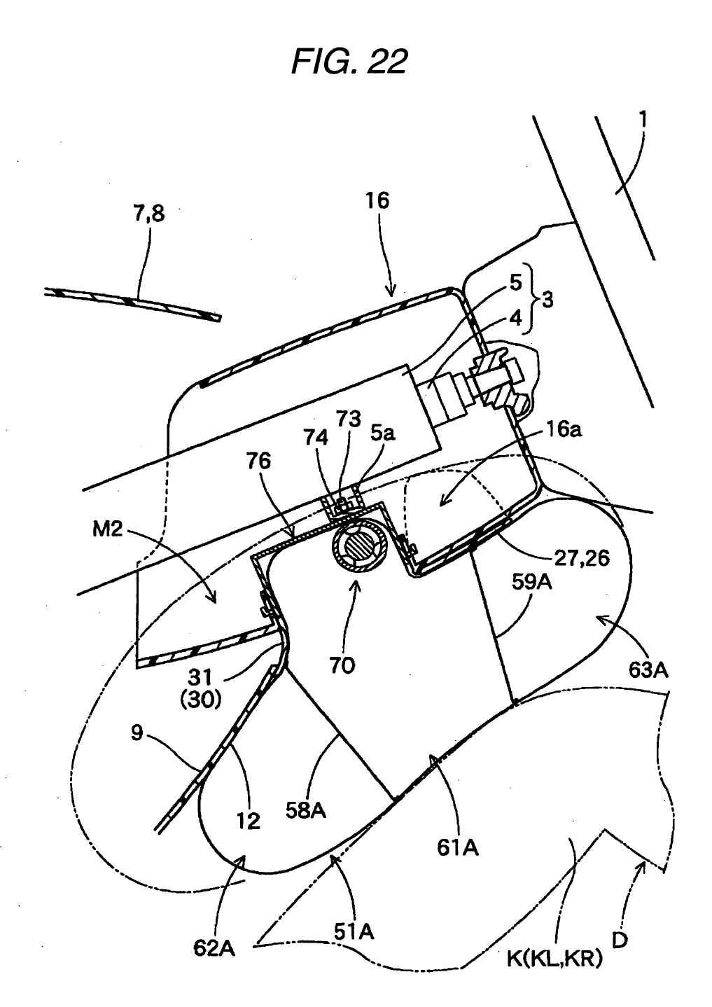

The airbag assembly can be installed in the vehicle in a similar way to the way in which the knee protection airbag system M1 of the first embodiment is installed in the vehicle. In addition, also in the knee protection airbag system M2 of the second embodiment, after the airbag system has been installed in the vehicle, when an activation signal in inputted into the main body 71 of the inflator 70 by way of a lead wire, not shown, the inflation gas is discharged from the gas discharge ports 71a provided on the main body 71, and the airbag 51A is deployed and inflated, whereby the inflation of the airbag 51A is completed as is shown in FIG. 22.

Also, in the knee protection airbag system M2 of the second embodiment, since the configuration of the airbag 51A is similar to the configuration adopted for the knee protection airbag system M1 of the first embodiment, the same function and advantage as those of the knee protection airbag system M1 of the first embodiment can be obtained.

In addition, in the knee protection airbag system M2 of the second embodiment, the airbag 51A is folded from the state in which the driver-side wall portion 52A and the column-side wall portion 53A are deployed flat and are then superposed one on the other through the preliminary folding in which the left and right or transverse end portions of the rear edge of the rear portion 63A (the left and right or transverse end portions 81b, 81c of the rear edge 81a of the folded airbag 81) are folded to create the folds C and are then folded back individually towards the column-side wall portion 53A side, then, the transverse contraction folding in which the transverse width dimension of the airbag 51A is decreased and the longitudinal contraction in which the longitudinal width dimension of the airbag 51A is decreased, whereby the airbag 51A is accommodated within the case 76. Namely, in the knee protection airbag system M2 of the second embodiment, the outlet path portions 60AB which are provided on the rear tether 59A side are closed by the intersecting folds C which are produced in the preliminary folding. Then, since the airbag 51A which has projected from the column cover 16 expands longitudinally and transversely and is then deployed while unfolding the folds produced by the preliminary folding, the flow of the inflation gas into the rear portion 63A can be delayed, whereas the inflation gas can be caused to flow into the front portion 62A quickly, whereby the front portion 62A can be inflated more quickly.

In the second embodiment, in the preliminary folding step, the area of the rear portion 63A is folded along the transverse direction in the vicinity of the rear tether 59 and is folded further into the interior of the airbag 51A while causing the rear edge 51b to approach the front edge 51a side. In the longitudinal contraction folding step, the area of the front portion 62A is roll folded by roll folding the front edge 85a towards the column-side wall portion 53A side. Because of this, the front portion 62A is deployed while unfolding the folds at the roll folded portion 86 along the lower surface 18a of the outer circumferential surface 18 of the column cover 16 and the rear surfaces 12, 13, 14 of the instrument panel 7 and suppressing the protrusion of the airbag 51A towards the driver D side as much as possible. In addition, since the rear portion 63A is also folded into the interior of the airbag 51A while causing the rear edge 51b to approach the front edge 51a side, the rear portion 63A is deployed such that the rear edge 51b projects rearwards along the lower surface 18a of the outer circumferential surface 18 of the column cover 16, whereby the rear portion 63A can be inflated smoothly while suppressing the interference with the column cover 16 and preventing the protrusion of the airbag 51A towards the driver D side as much as possible.

In the second embodiment, the airbag 51A is folded through the preliminary folding in which the area of the rear portion 63A is folded along the transverse direction and is folded further so as to decrease the longitudinal width dimension, and thereafter, with the intersecting folds C created, the portions lying in the vicinity of the left and right or transverse ends of the rear tether 59 are folded back towards the column-side wall portion 53A side. Namely, in the second embodiment, while the airbag 51A is folded so as to decrease its longitudinal width dimension during the preliminary folding, the folding procedure of the airbag is not limited thereto. Therefore, for example, the airbag may be made to be folded simply from the state in which the column-side wall portion and the driver-side wall portion are deployed flat through a preliminary folding in which the left and right or transverse end portions of the rear tether are folded to create folds and are then folded back towards the column-side wall portion side and thereafter a longitudinal contraction folding in which the longitudinal width dimension of the area of the rear portion is decreased. However, as has been described in the embodiment, in the event that the configuration is adopted in which the area of the rear portion is folded before the preliminary folding step, since the rear edge 51b of the airbag 51A can be folded into the interior of the airbag 51A, as has been described before, the rear portion 63A can be deployed quickly while suppressing the interference with the column cover 16 and the driver D. In consideration of this point, as in the case with the embodiment, the area of the rear portion is preferably folded before the preliminary folding step.

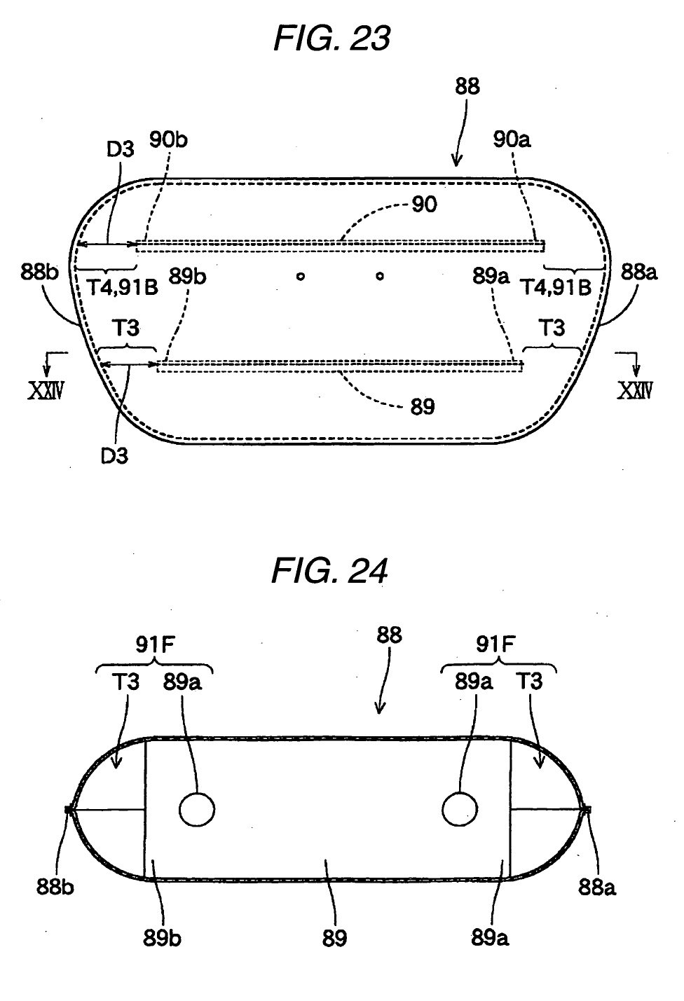

In the airbags 51, 51A which are used in the knee protection airbag systems M1, M2 of the first and second embodiments, the gaps T1, T2 which are defined between the front tethers 58, 58A and the rear tethers 59, 59A and the left edges 51c and the right edges 51b of the airbags 51, 51A constitute the outlet path portions 60F, 60AF, 60B, 60AB, and by making the open width dimension D1 of the gaps T1 on the front tethers 51, 51A larger than the open width dimension D2 of the gaps T2 on the rear tethers 59, 59A, the open area of the outlet path portions 60F, 60AF which allow the inflation gas G to flow out into the front portions 62, 62A is set larger than the open area of the outlet path portion 60B which allows the inflation gas G to flow out into the rear portion 63. However, the configurations of the outlet path portions are not limited thereto. For example, as is shown in FIGS. 23 and 24, a configuration may be adopted in which gaps T3 defined between a front tether 89 and a left edge 88a and a right edge 88b of an airbag 88 and gaps T4 defined between a rear tether 90 and the left edge 88a and the right edge 88b of the airbag 88 are made to have substantially the same open width dimension D3, and an opening 89a is formed in the vicinity of a transverse end portion of the front tether 89. In the airbag 88 configured in this way, on the rear tether 90 side, the gaps T4 defined between the rear tether 90 and the left edge 88a and the right edge 88b of the airbag 88 constitute outlet path portions 91B, while on the front tether 89 side, the gaps T3 defined between the front tether 89 and the left edge 88a and the right edge 88b of the airbag 88 and the opening 89a constitute outlet path portions 91F, whereby the open area of the outlet path portions 91F is set larger by the amount of the opening 89a than the open area of the outlet path portions 91B. In addition, in FIG. 24, although openings 89a are formed in the vicinity of both left and right ends of the front tether 89, many openings which assist the function of the outlet path portions may be provided so as to scatter over the whole transverse area of the front tether, provided that their size is not so large as to affect the rectifying effect of the inflation gas G by the front tether 89.

In addition, in the knee protection airbag systems M1, M2 of the first and second embodiments, the inflation gas discharged from the main bodies 37, 71 of the inflators 36, 70 is guided by the diffuser 39 and the retainer 72 and flows along the transverse direction into the airbags 51, 51A. Namely, in the initial inflation stage of the airbags 51, 51A, the inflation gas G is guided by the diffuser 39 and the inner circumferential surface of the retainer 72 and flows towards the left door portion 28 and the right door portion 29 of the door portion 26. Because of this, to describe the embodiments by taking the first embodiment for example, firstly, as is shown in FIGS. 14A and 14B, the left door portion 28 and the right door portion 29 of the door portion 26 are push opened, and the roll folded portions 67L, 67R project while unfolding the folds from the opening formed by the left door portion 28 and the right door portion 29 being push opened. Then, as this occurs, in the embodiment, the auxiliary left door portion 32 and the auxiliary right door portion 33 are also push opened. Thereafter, the airbag 51 deploys the area of the central portion 61 widely in the transverse direction and, as is shown in FIGS. 15A and 15B, push opens the lower door portion 27 of the door portion 26 and the auxiliary lower door portion 31 and the central portion 61 is then deployed so as to increase its thickness whereby the inflation gas is caused to flow into the front portion 62 and the rear portion 63 by way of the outlet path portions 60F, 60B, whereby the inflation of the airbag 51 is completed. Namely, in the knee protection airbag systems M1, M2 of the first and second embodiments, the left door portion 28, the right door portion 29, the auxiliary left door portion 32 and the auxiliary right door portion 33 are push opened at first, and thereafter, the lower door portion 27 and the auxiliary lower door portion 31 are push opened, whereby the airbags 51, 51A can be deployed and inflated widely in the transverse direction in an ensured fashion in the initial stage of inflation. Of course, since the invention is configured such that the airbags 51, 51A can be deployed quickly in the transverse direction by the configurations of the airbags 51, 51A themselves, the invention can, of course, be applied to a vehicle which adopts a column cover having a door portion which is configured such that the whole of the door portion is opened quickly and largely, as well. Also when the knee protection airbag systems M1, M2 of the invention are installed in such a vehicle, the central portion 61, 61A can be deployed widely in the transverse direction at first in the initial inflation stage of the airbags 51, 51A.

What is claimed is:

1. A knee protection airbag system installed in a lower portion in a column cover which covers a steering column, comprising:
a folded airbag; and
an inflator for supplying an inflation gas into the airbag which are accommodated in the lower portion in the column cover, whereby when activated, the inflation gas is supplied into the airbag from the inflator, and the airbag is caused to project from the column cover while being deployed and inflated so as to complete inflation thereof to be disposed at a front side of knees of the driver in a longitudinal direction of a vehicle, while covering a lower surface side of the column cover and a rear surface side of an instrument panel on both left-hand and right-hand sides of the column cover, wherein
the airbag comprises a driver-side wall portion which is disposed on a side facing the driver and a column-side wall portion which is disposed on a side facing the column cover when the airbag is completely inflated and has an inlet port portion which is made to be disposed in the vicinity of a longitudinally and transversely center thereof when the airbag is completely inflated so to be connected to the inflator so as to allow the inflation gas from the inflator to flow into an interior of the airbag, wherein
a front tether and a rear tether which connect the driver-side wall portion and the column-side wall portion so as to restrict a thickness of the airbag when the airbag is completely inflated are provided so as to extend along substantially a transverse direction on a front side and a rear side of the inlet port portion inside the airbag, wherein
the front tether and the rear tether are made to rectify the inflation gas which has flowed into the interior of the airbag from the inlet port portion so as to cause the inflation gas to flow towards both left and right ends of a central portion in the airbag which is made up of an area surrounded by the front tether and the rear tether and thereafter to cause the inflation gas to flow out into a front portion in the air bag which is made up of an area lying forwards of the front tether and a rear portion in the airbag which is made up of an area lying rearwards of the rear tether by way of outlet path portions provided at transverse end portions of the airbag when the airbag is completely inflated, and wherein
the outlet paths portions for causing the inflation gas to flow out into the front portion are made larger in a total sum of open areas than the outlet path portions for causing the inflation gas to flow out into the rear portion.

2. A knee protection airbag system as set forth in claim 1, wherein
the airbag is formed into a substantially trapezoidal configuration in which a transverse width dimension gets narrower towards a front edge side as an external configuration resulting when the airbag is completely inflated, and wherein a volume of the front portion is made smaller than a volume of the rear portion when the airbag is completely inflated.

3. A knee protection airbag system as set forth in claim 1, wherein
the airbag is made by joining the driver-side wall portion and the column-side wall portion which are made to have substantially the same external shapes to each other along outer circumferential edges of the driver-side wall portion and the column-side wall portion, and is accommodated by being folded from a state in which the driver-side wall portion and the column-side wall portion are deployed flat to be superposed one on the other firstly through a longitudinal contraction folding in which the driver-side wall portion and the column-side wall portion are folded so as to decrease a longitudinal width dimension and then through a transverse contraction folding in which the driver-side wall portion and the column-side wall portion are folded so as to decrease the transverse width dimension, the transverse contraction folding being made up of a roll folding in which transverse edge portions of the airbag are folded into a roll towards the driver-side wall portion.

4. A knee protection airbag system as set forth in claim 1, wherein
the airbag is made by joining the driver-side wall portion and the column-side wall portion which are made to have substantially the same external shapes to each other along outer circumferential edges of the driver-side wall portion and the column-side wall portion, and is accommodated by being folded from a state in which the driver-side wall portion and the column-side wall portion are deployed flat to be superposed one on the other firstly by implementing a preliminary folding in which transverse end portions of rear edges of the rear portions of the driver-side wall portion and the column-side wall portion so superposed are folded so as to intersect the rear tether but not to intersect the front tether and the transverse end portions are then folded back individually towards the column-side wall portion and folding thereafter the driver-side wall portion and the column-side wall portion so preliminarily folded firstly through a longitudinal contraction folding in which the driver-side wall portion and the column-side wall portion are folded so as to decrease a longitudinal width dimension and a transverse contraction folding in which the driver-side wall portion and the column-side wall portion are folded so as to decrease the transverse width dimension.
